(19) United States
(12) Patent Application Publication
(10) Pub. No.: US 2025/0068422 A1
(43) Pub. Date: Feb. 27, 2025

(54) METHOD AND APPARATUS FOR PARTIAL VIRTUALIZATION IN A PROCESSOR

(71) Applicants: Duane GALBI, Wayland, MA (US); Christopher J. HUGHES, Santa Clara, CA (US); Dan BAUM, Haifa (IL); H. Peter ANVIN, San Jose, CA (US); Stijn EYERMAN, Evergem (BE)

(72) Inventors: Duane GALBI, Wayland, MA (US); Christopher J. HUGHES, Santa Clara, CA (US); Dan BAUM, Haifa (IL); H. Peter ANVIN, San Jose, CA (US); Stijn EYERMAN, Evergem (BE)

(21) Appl. No.: 18/942,082

(22) Filed: Nov. 8, 2024

(51) Int. Cl. G06F 9/30; G06F 9/46

(52) U.S. Cl. CPC G06F 9/3009; G06F 9/30123; G06F 9/461

(57) ABSTRACT

Methods, apparatus, and computer programs are disclosed for context switching. In some embodiments, a method comprises dedicating a first subset of a plurality of vector registers to a first thread of a plurality of threads for thread execution; and responsive to a context switch from the first thread to a second thread, bypassing saving a state of the first subset of the plurality of vector registers; and saving a state of a second subset of the plurality of vector registers, wherein the second subset of the plurality of vector registers is not dedicated to the first thread, and wherein the first and second subsets are mutually exclusive.

### BACKGROUND ART

A processor in a computing system typically allows its cores to be fully virtualized, and every thread has access to the full resources of a core in the full virtualization. However, running some types of workloads may involve substantial amounts of data buffering to maintain the required data processing throughput. For the operating system to perform a full context swap and a full virtualization of the core, it could take a substantial amount of time and overhead to store the required state. Such full virtualization may thus be cumbersome to perform and consume too many resources of the computing system.

### BRIEF DESCRIPTION OF THE DRAWINGS

The disclosure may best be understood by referring to the following description and accompanying drawings that are used to show embodiments of the disclosure.

FIG. 1 illustrates partial vector register virtualization on a computing system per some embodiments.

FIGS. 2A-2C illustrate delayed state save on a context switch per some embodiments.

FIG. 3 illustrates commands to execute used in vector register state reduction per some embodiments.

FIGS. 4A-4B illustrate execution of instructions with corresponding timeline and context switch per some embodiments.

FIG. 5 illustrates a flow diagram for partial virtualization operations per some embodiments.

FIG. 6 illustrates a flow diagram for thread state management per some embodiments.

FIG. 7 illustrates a processor with a set of cores and resources for thread execution per some embodiments.

FIG. 8 illustrates an example computing system.

FIG. 9 is a block diagram illustrating a computing system 900 configured to implement one or more aspects of the examples described herein.

FIG. 10A illustrates examples of a parallel processor.

FIG. 10B illustrates examples of a block diagram of a partition unit.

FIG. 10C illustrates examples of a block diagram of a processing cluster within a parallel processing unit.

FIG. 10D illustrates examples of a graphics multiprocessor in which the graphics multiprocessor couples with the pipeline manager of the processing cluster.

FIGS. 11A-11C illustrate additional graphics multiprocessors, according to examples.

FIG. 12A is a block diagram illustrating both an example in-order pipeline and an example register renaming, out-of-order issue/execution pipeline according to examples.

FIG. 12B is a block diagram illustrating both an example in-order architecture core and an example register renaming, out-of-order issue/execution architecture core to be included in a processor according to examples.

FIG. 13 illustrates examples of execution unit(s) circuitry, such as execution unit(s) circuitry.

FIG. 14 is a block diagram of a register architecture according to some examples.

FIGS. 15A-15B illustrate thread execution logic including an array of processing elements employed in a graphics processor core according to examples described herein.

FIG. 16 illustrates an additional execution unit, according to an example.

### DETAILED DESCRIPTION

In the following description, numerous specific details are set forth. However, it is understood that embodiments of the disclosure may be practiced without these specific details. In other instances, well-known circuits, structures, and techniques have not been shown in detail in order not to obscure the understanding of this description.

Bracketed text and blocks with dashed borders (such as large dashes, small dashes, dot-dash, and dots) may be used to illustrate optional operations that add additional features to the embodiments of the disclosure. Such notation, however, should not be taken to mean that these are the only options or optional operations, and/or that blocks with solid borders are not optional in some embodiments of the disclosure.

References in the specification to “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “connected” means a direct electrical or magnetic connection between the things that are connected, without any intermediary devices, while the term of “coupled” means either a direct electrical or magnetic connection between the things that are connected or an indirect connection through one or more passive or active intermediary devices. The term “circuit” means one or more passive and/or active components that are arranged to cooperate with one another to provide a desired function. The terms “computing system,” “compute system,” “computer system,” and “computer” are used interchangeably herein. The term “set” means any positive whole number of items including one item.

Embodiments provide partial virtualization in a computing system, where the state of one or more architectural resources is partially saved or saved with delay upon a context switch; and additionally/alternatively, the state of the one or more architectural resources comprises one or more commands to store or reload the content of the one or more architectural resources, instead of the content itself.

### Partial Virtualization

Virtualization in a computer processor allows multiple operating systems and applications to run on the same physical hardware simultaneously by abstracting and dividing the physical resources of the computer processor. The application may include a Virtual Machine Monitor (VMM), also called a hypervisor, which manages and monitors Virtual Machines (VMs) that may run their respective guest operating systems/applications. The physical resources that can be virtualized include registers, caches (e.g., L1 to L3 caches), and units/circuits/logic per physical core or small group of physical cores to perform one or more specific tasks (e.g., a tightly coupled Direct Memory Access (DMA) engine or a thread synchronization unit). The physical resources may be within or outside of processor cores of the computer processor. Note that these physical resources are also referred to as architectural resources of the processor and the two terms are used interchangeably herein.

A partial virtualization in a processor allows the embodiments to have a core and operating system(s) that have not been burdened with all the resources required to fully virtualize the core, and significantly more physical resources may be dedicated to specific threads consequently. For example, a core may be virtualized with one thread on the core owning the physical resources necessary to achieve the highest performance for the thread, and another set of more generically virtualized threads to perform more general tasks. A thread discussed herein may be a sequence of instructions (software thread) to be executed in a processor; and it may also be a hardware thread (also referred to as logical processor), which is a set of components of a processor core that can execute a sequence of instructions independently, such as hyper-threading (HT) or simultaneous multithreading (SMT) that allows a single processor core to execute multiple sequences of instructions simultaneously.

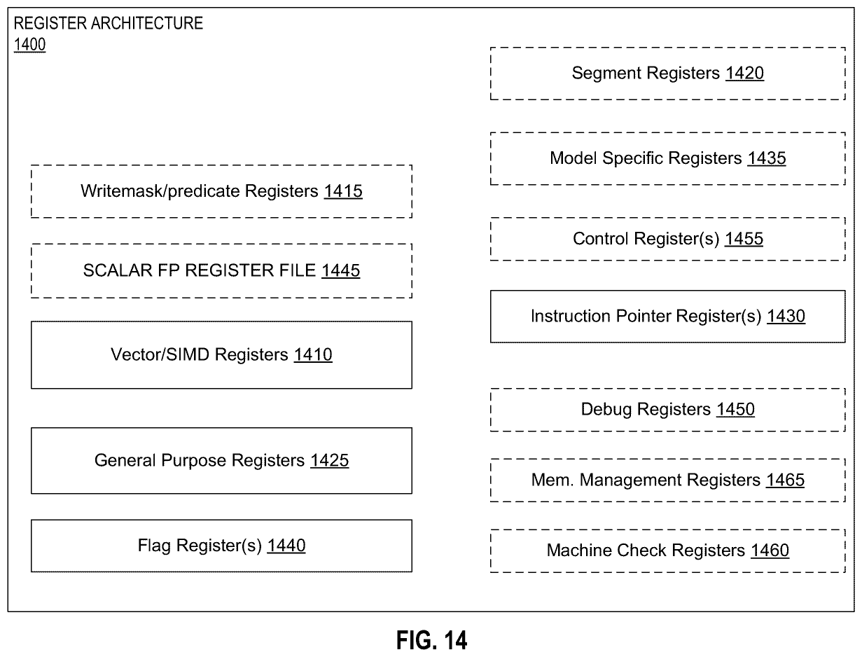

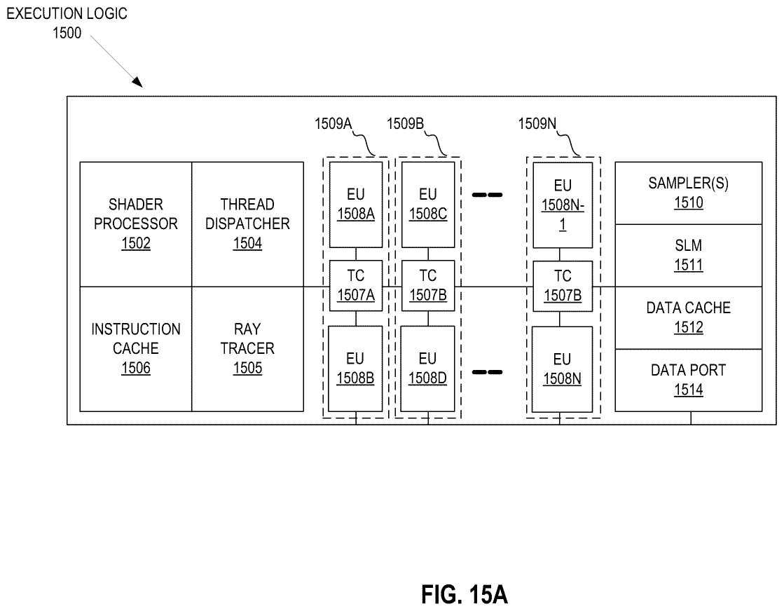

To simplify the discussion, registers are used as examples of the physical resources of a processor to explain the partial virtualization discussed herein. There are different types of registers in some computing systems, including general purpose registers to store temporary data and intermediate results during instruction execution, special-purpose registers for specific tasks (e.g., program counter, stack pointer, status/flag register, memory-mapped input/output (MMIO) register), and vector/single-instruction, multiple-data (SIMD) registers for parallel data processing. Some of the register types are discussed in more detail relating to FIG. 14. Note that a vector/SMID register may also be referred to as tile or matrix register when it may be used to handle large matrix computations in parallel. Vector registers (VRs) are used in examples herein and they are considered as synonyms of SIMD registers, tile registers, and matrix registers.

A vector register tends to be much larger in size than other registers in the same computing system. For example, each vector register may be 1,024 bytes in a computing system while its general-purpose register may have a 16-bit, 32-bit, or 64-bit width as an example of FIG. 14. A computing system may implement 8 vector registers to improve computational performance, which is critical to some workloads in applications such as artificial intelligence (AI) and machine learning (ML). The AI/ML workloads include (1) training workloads such as model training (e.g., large language models (LLMs) or retrieval-augmented generation (RAG)), hyperparameter tuning, transfer learning, and distributed training; (2) inference workloads such as real-time inference, batch inference, edge inference; (3) data processing workloads such as data preprocessing, data labeling, Extract, Transform, Load (ETL), and other data analytics; (4) model evaluation and validation workloads including model testing, cross-validation, A/B testing; (5) deployment workloads including model serving using machine learning algorithms, continuous integration and deployment (CI/CD) pipelines tailored for machine learning, and model monitoring including models using neural networks, Bayesian networks, and decision trees; (6) optimization workloads including model compression, quantization, pruning.

While these AI/ML workloads may be executed by a core through the set of vector registers, saving the state of the 8 K vector registers burdens the operating system/application coordinates computation using these registers.

Applying the partial virtualization approach, one can assign one or more vector registers directly to a thread in some embodiments. In this case, these registers are no longer part of the general state of a processor core and would not need to be saved and restored by the operating system/application on a context switch.

Context switch is a process in a processor where a core switches from executing one thread to another so that the threads may share resources of the processor effectively. Context switch is also referred to as context switching, thread swap, thread swap event, thread context swap, state swap, or similar terms. Context switch includes save and restore operations, where (1) the current state of the running thread on a core is saved, (2) the saved state of the next thread to be executed is then loaded on the core, and (3) the core executes the next thread from the saved state.

The state of a thread, also referred to as context state of the thread, is the collection of information that defines the execution state of the thread at a given moment. The information includes content/values of various processor-specific registers, program counters, stack pointers, status flags, caches, DMA engines, and thread synchronization units. The state (or context state) of a register (or other physical resources) at a moment includes the values stored in the register (or other physical resources) at the moment. Note that the terms of context state and state of a physical resource are used interchangeably herein unless noted otherwise.

In the partial virtualization approach, one or more vector registers may be assigned to a thread and their states are not to be saved on a context switch. In some embodiments, the thread would use a special operating system (OS) application programming interface (API) to request access (e.g., read/write) to these vector registers, and the OS in conjunction with core hardware would ensure only that thread touches the registers.

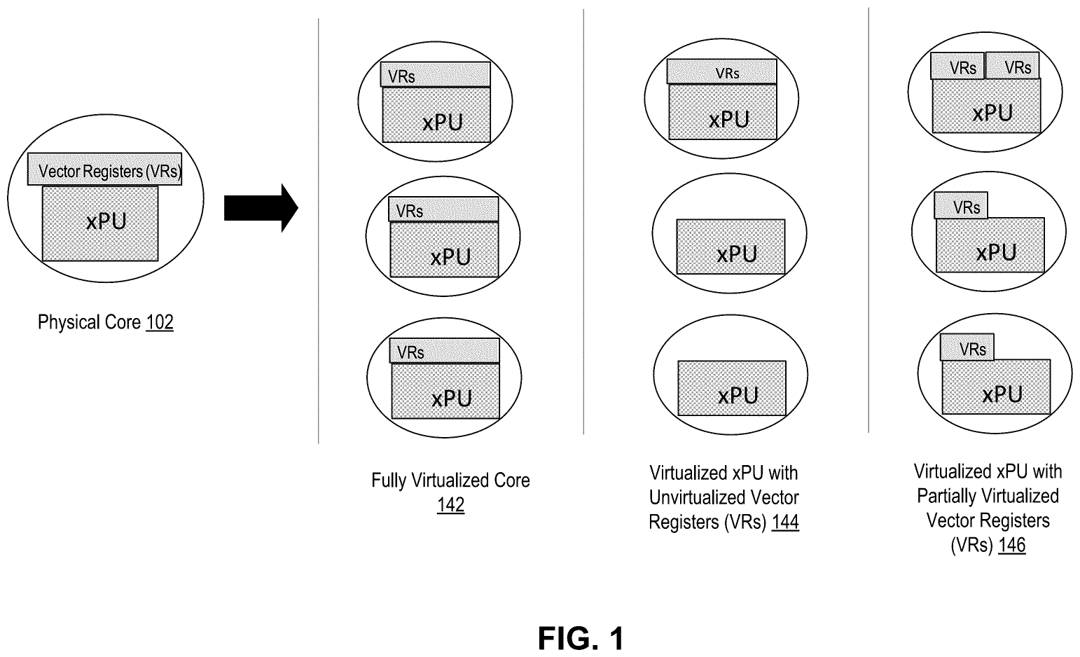

FIG. 1 illustrates partial vector register virtualization on a computing system per some embodiments. The left of the figure shows a physical core 102, shown as an xPU core, that has a set of vector registers. The xPU refers to a processing unit such as one of central processing units (CPUs), graphics processing units (GPUs), tensor processing units (TPUs), infrastructure processing units (IPUs), edge processing units (EPUs), and data processing units (DPUs).

Reference 142 shows a fully virtualized core, where the three threads share the xPU core and the virtual registers are fully virtualized when the core is virtualized, and the virtual registers are used by the running thread on the core. In contrast, references 144 and 146 show partial virtualization. In the former, the virtualized xPU core includes non-virtualized vector registers that are assigned to one thread only and the other threads have no access to the vector registers; and in the latter, a subset of the vector registers is virtualized thus accessible to a running thread while another subset is assigned to one thread only. In some embodiments, the thread to which a specific vector register is not assigned is prevented from accessing the specific vector register even when the thread is running on the xPU core. A “subset” of an original set, as used herein, contains some but not all element of the original set, and it is also referred to as a proper subset of the original set.

The partial thread virtualization in a virtualized core thus allows assigning some vector registers to a thread exclusively while virtualizing other vector registers to be shared by that thread and other threads. Other architectural resources may be assigned/virtualized in the partial thread virtualization. Additionally, the partial thread virtualization may be performed across different architectural resources. For example, vector registers may be assigned to a thread while general registers are virtualized to be shared by that thread and other threads. When only part or all the vector registers are virtualized, the operating system state of the thread must be enhanced to include which non-virtualized vector registers are owned by the thread (dedicating the vector registers to the thread). In addition, there must be additional core hardware that keeps a thread that is not assigned a specific vector register from reading or modifying this specific vector register. For example, a hardware bit may be used to control access to the non-virtualized VR in some embodiments. If one thread attempts to use the registers without the appropriate hardware bit set it creates an exception that triggers an OS call, and the OS can decide whether to give access (e.g., setting the appropriate hardware bit).

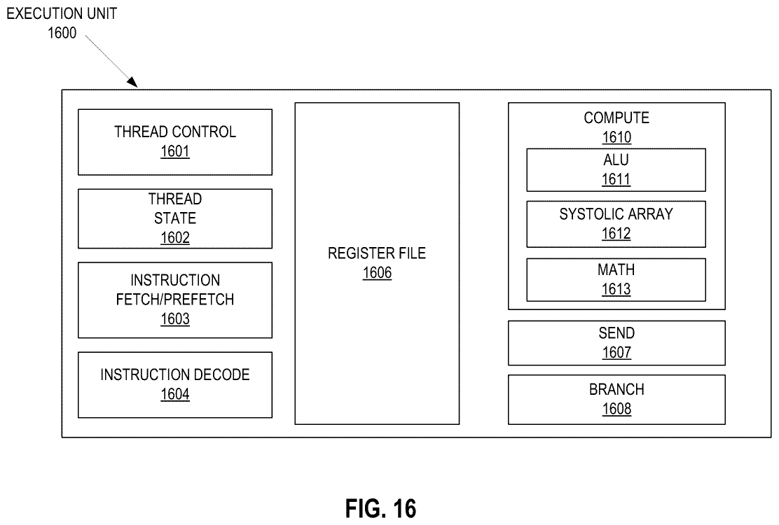

In the partial virtualization, the assignment of vector registers to a particular thread on a xPU core allows that thread to uninterruptedly maintain the state of the vector registers even when another thread is executed on the core, so that no state save/restoration for the vector registers needs to be performed when the particular thread is swapped out and then back into the core. The core is thus virtualized with the particular thread on the core owning the physical resources necessary to achieve high performance (e.g., having more vector registers to perform AI/ML tasks), and another set of more generically virtualized threads to perform general tasks, and the overall performance of the core is improved as a result. The thread assignment and scheduling may be performed in execution unit 1600 as shown in FIG. 16 in some embodiments. The execution unit 1600 may be implemented within a processor core and register file 1606 includes vector registers discussed herein.

### Delayed State Save

It is noticed that fully virtualizable resources might often be unused by multiple threads. For example, vector registers perform specific tasks (e.g., SIMD operations) that many applications do not use. Currently, the operating system/application coordinating threads is burdened with the overhead of a full context switch when switching to a thread even when the thread switched in does not use these resources. To address the issue, some embodiments perform a delayed state save on context switch, where the state of some resources (e.g., vector registers) are saved at a time later than the context switch. The delayed state save allows the core and the operating system/application to only virtualize a resource during a thread swap when the thread swapping in (“destination thread”), rather than the thread swapping out (“source thread”), needs to use this resource. This level of partial virtualization can be applied to resources such as vector registers to reduce the overhead of a context switch.

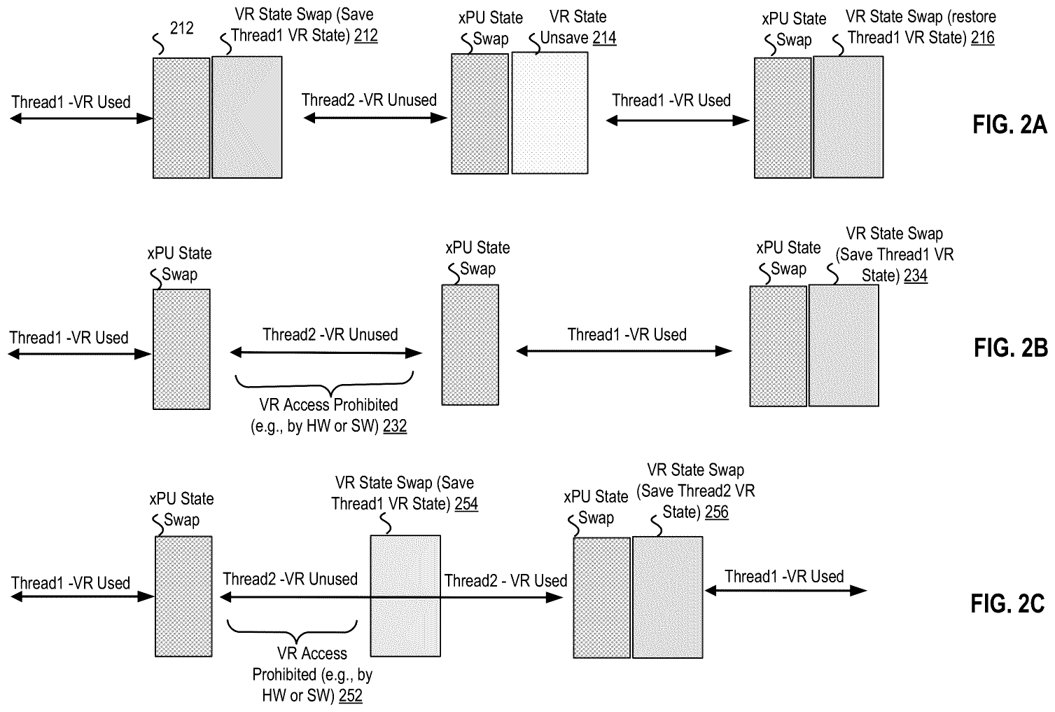

FIGS. 2A-2C illustrate delayed state save on a context switch per some embodiments. In these embodiments, a long running thread may use the vector registers, and that thread may be interrupted by shorter threads that either do not use the vector registers or make little use of the vector registers. When the shorter threads do not use these vector registers, the delayed state save can eliminate the overhead of swapping these vector registers during a context switch.

FIG. 2A illustrates the regular state save of vector registers upon context switch, where Thread I uses a set of vector registers of a core. When Thread 1 is swapped out of the core, the xPU state swap and vector register state swap are performed, where the former saves the state of Thread 1 (other than the state of the vector registers) and the latter saves the state of the vector registers as shown at reference 212. In this example, Thread 2 is a shorter thread that does not use the vector registers during its execution on the core. When the state of Thread 2 is saved upon the context switch back to Thread 1, only the xPU state swap is performed while no state of the vector registers needs to be saved as shown at reference 214. The swapped-in Thread 1 then restores the saved state of the vector registers through the vector register state swap at reference 216, even though the vector registers are unused during the execution of Thread 2. The two vector stage swaps at 212 and 216 for Thread 1 are unnecessary since Thread 2 has not used the vector registers as the running thread on the core.

FIG. 2B illustrates a first delayed state save approach on a context switch per some embodiments. In this approach, the operating system and/or an application keeps track of what threads are using the virtualized vector registers. Only if the destination logical core was previously running a thread (e.g., Thread 2) using the virtualized vector registers, and that thread didn't complete or release the registers, the operating system/application needs to swap vector registers to save the state of outgoing thread (e.g., Thread 1) on a thread context swap. The thread that has not requested the vector registers (e.g., Thread 2) is kept from accessing the vector registers in some embodiments, through hardware/software as shown at reference 232. In cases where a thread (e.g., Thread 2) does not have access to the vector registers but requests the registers during its execution, the operating system (OS) and/or applications is to perform a vector register save before allowing the thread access to the vector registers, as shown in the vector register state swap at reference 234. The vector register state swap in FIG. 2B is delayed until the running thread (e.g., Thread 2) requests to use the vector registers, in which case the state of vector register for Thread 2 is swapped in (restored Thread 2), otherwise the vector registers are used by the earlier thread with uncompleted tasks (Thread 1).

By delaying the state swap of an architectural resource (e.g., vector registers) to be decoupled with context switching and making the state swap of the architectural resource to be based on the request for a vector register by the running thread, the core may avoid unnecessary state save/restore of the architectural resource thus saves execution and storage resources of the corresponding computing system that would be consumed by the state swap of the architectural resource.

FIG. 2C illustrates a second delayed state save approach on a context switch per some embodiments. Similar to the first approach, the thread that has not requested the vector registers (e.g., Thread 2) is kept from accessing the vector registers in some embodiments, through hardware/software as shown at reference 252. Further, the vector register state swap occurs when the new thread (e.g., Thread 2) attempts to use a vector register. In this case, the vector register state swap could happen only when the vector register is used even if the thread has been granted access to the vector registers earlier. The attempt to use a vector register may be detected by hardware and/or software and signaled through an operating system (OS) call in some embodiments. The hardware and software could indicate to the OS through the OS call that a vector register was accessed. As shown, the vector register state swap occurs at reference 254 upon the detection of Thread 2 using a vector register. When Thread 1 is to swap into the core in a subsequent context switch, the state swap of xPU and vector registers are performed as shown at reference 256.

In some embodiments of delayed state save, the OS/application could swap all the vector registers allocated to the running thread and enable the thread to use these registers, once the thread attempts to use a vector register. Yet the more information the hardware/software supplies about what vector register was accessed or what vector registers could be accessed in the future, the more exact the OS/application could be in swapping and enabling the thread (e.g., Thread 2) to use specific vector registers. For example, the access of the vector registers by threads may be saved in a record, and which vector registers to be included for swapping and thread access enabling in future context switching may be identified based on the record. For example, the record indicates in each access which vector registers are accessed and whether the access is to read or write, and which thread access the vector registers. This information may be used to determine the state of which vector registers are to be swapped upon a thread swap.

The identification of the specific vector registers to be included in a vector register state swap for a thread based on the record may be implemented through heuristic methods or machine learning models. For example, if a context switch to a thread involves a delayed vector register state swap of a particular set of vector registers, when the thread is switched in again, the same set of vector registers may be saved upon access request/attempt. The machine learning models may use supervised learning, unsupervised learning, semi-supervised learning, or other types of learning. They can use artificial neural networks, decision trees, support-vector machines, regression analysis, Bayesian networks, genetic algorithms, or any other framework. The machine learning models may be trained with the one or more goals of reducing resources taken in context switching, increasing performance of one or more types of workloads on the processor, or a combination of the two in some embodiments.

By delaying the state swap of an architectural resource (e.g., vector registers) to be based on the attempted use of a vector register by the running thread, the core in the second approach may perform even less save/restore of the architectural resource comparing to the first approach, thus provide more saving on the execution and storage resources of the corresponding computing system.

### State Size Reduction

The state of an architectural resource is typically considered as the content of the architectural resource. For example, the set of values stored in a vector register is often viewed as the state of the vector register. Yet some embodiments of partial virtualization consider the one or more commands may provide information necessary to read or write an architectural resource as the state of the architectural resource. Note that the terms of command and instruction are used interchangeably herein.

In some embodiments, to save the context state of a vector register is to save the information obtained through executing the command necessary to associate a user space memory destination with the state of the vector register, or reload the vector register from a user space memory source. The command-based state save/restore may save significant storage resources in a context switch. In the computing system above with the general-purpose register of 32-bit width and vector register of 1,024-byte width, this reduces the required context state for a vector register from 1K bytes to approximately 16 bytes that contains information needed to identify the user space memory location that saves the context state of the vector register. The information may include the address of the user space memory location or metadata about the association of the user space memory location with the vector register.

During thread context swap, commands are used to (1) write the contents of modified vector registers of the current thread to the user memory, and (2) read the contents of in-use vector registers of the destination thread (the thread swapping-in) from the user memory. Existing commands may be used in partial virtualization in these embodiments. For example, a tile load instruction is used to read a block of data (a tile) such as a sub-block of a matrix from user memory, and the tile load instruction may be used to set the state of the destination vector register (also referred to as tile register) as well.

The commands to map to the state of a vector register includes ones to: (1) read the vector register data and set the vector register context (standard tile-read as known) (e.g., instruction TREAD( ) discussed herein), (2) set the vector register context (to prepare a write-register) (e.g., instruction TSA( ) discussed herein); (3) write the vector content data using the vector register context (to perform tile-write, e.g., instruction TSTORE( ) discussed herein); (4) read the vector data content using the vector register context (used to restore after thread swap) (e.g., instruction TRD( ) discussed herein); and (5) save and restore the new context of the vector registers. The vector register context would be the virtual address-based description of the memory locations to read and/or write the data content of the vector register.

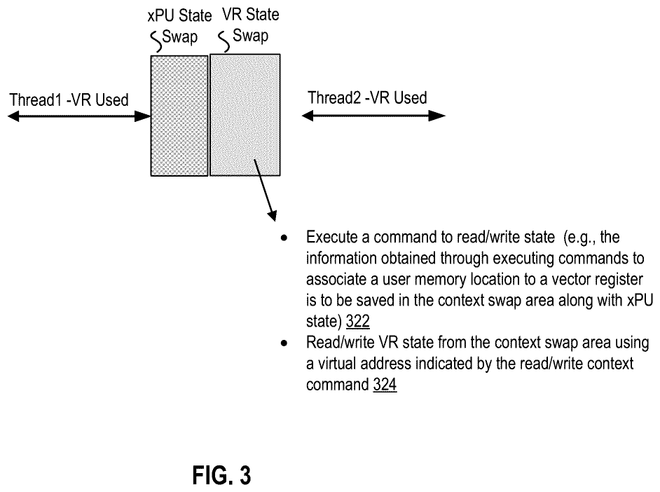

FIG. 3 illustrates commands to execute used in vector register state reduction per some embodiments. The xPU and vector register state swaps are performed when a core switches from the first thread (Thread 1) to use vector registers to the second thread (Thread 2). Note that as discussed in the Delayed State Save Section, the xPU and vector register state swaps may happen separately with the latter lagging behind the former and responsive to access request/attempt of the second thread.

Before a VR is modified, a command to set the vector register context (e.g., TSA( )) assigns a destination user memory address to the vector register context. A vector register store would not take a physical address specification as the input parameter, e.g., address, stride, or flag, but instead takes a vector register whose context contained the appropriate user memory specification. For the vector register state swap, these embodiments implement instructions to read and write the vector register state. The context swap area of the user memory space for vector register state swap may store the state save/restore information obtained through executing commands (e.g., TSA( ) and TSTORE( ) to read data from and write data to the memory, as shown at reference 322. To perform the vector register state swap, a core may read/write vector register state from the context swap area using a virtual address indicated by the read/write context command as shown at reference 324.

Using the commands for vector register state swap may allow these embodiments to read and write 16-byte context state per tile as the commands may be stored using merely 16 bytes, and that is in contrast to read or write the content of the corresponding tile using 1K bytes, the typical tile size in some embodiments.

In some embodiments, synchronization is performed in the vector register state reduction. For example, synchronization may be performed by upper-level software. The synchronization is to ensure that the tile/vector source memory location behind tile-read and the tile/vector destination memory location are stable for the lifetime of the vector register.

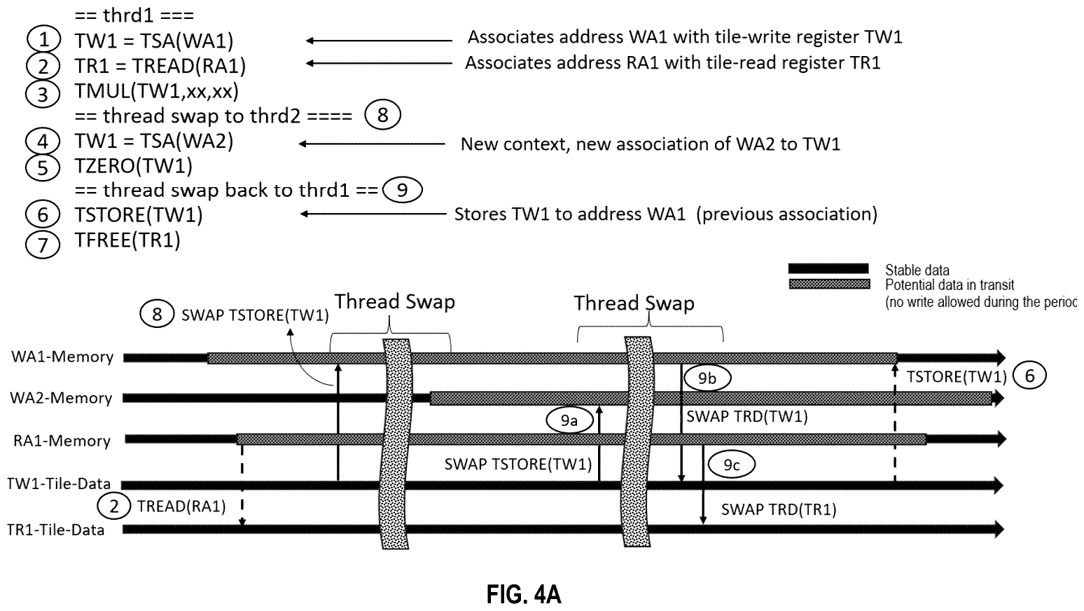

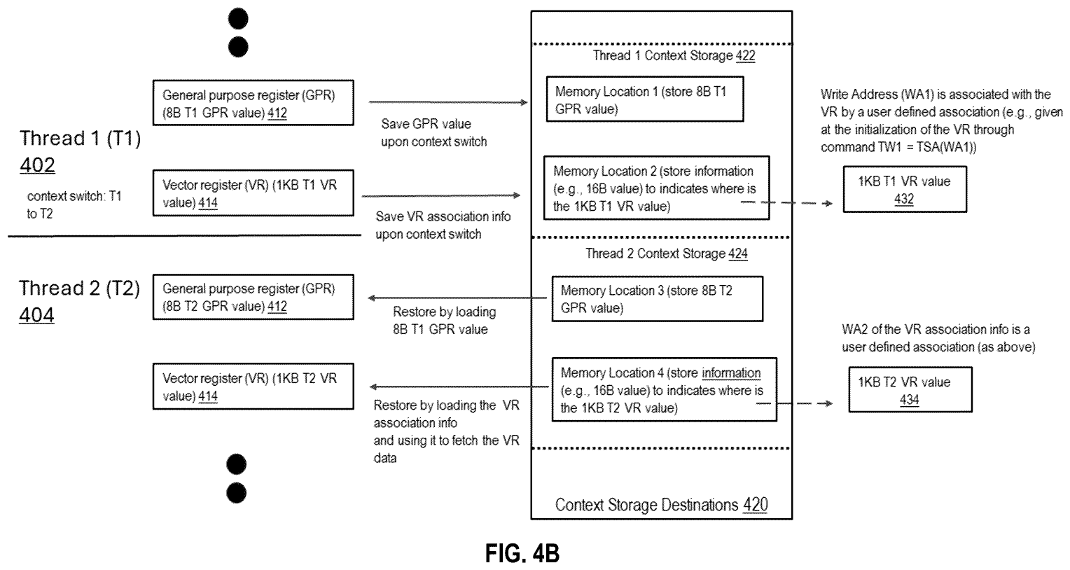

FIGS. 4A-4B illustrate execution of instructions with corresponding timeline and context switch per some embodiments. FIG. 4A illustrates execution of instructions with corresponding timeline per some embodiments. A sequence of instructions is shown in a code snippet at the top half of the figure while corresponding execution timeline of some instructions is shown at the bottom half. The instruction is executed through Thread 1 and Thread 2. Circles 1 to 9 indicate instructions and operations to be explained in further detail below, and operations 9a-9c correspond to ones performed in the same thread swap from Thread 2 back to Thread 1.

As shown, Instructions 1 to 3 are executed through Thread 1. A pair of tile registers are involved, one is for writing data, called tile-write register TWI and the other is for reading data, called tile-read register TR1.

Instruction 1: The TSA (<memory specification>) instruction associates/assigns a destination user memory address to the tile register context, and TW1=TSA(WA1) associates/assigns user memory address WA1 (write address 1) with tile-write register TWI that contains tile data, so that the tile-write register TW1 may be written to WA1.

Instruction 2: The TREAD( ) instruction associates/assigns a source user memory address to read a tile register content and read the content into a tile register. TR1=TREAD(RA1) associates/assigns the source user memory address RA1 (read address 1) with tile-read register TR1 and reads the tile data from RA1 into the tile-read register TR1. The read of tile data from RA1 to TR1 through TREAD(RA1) is shown in the timeline illustration at Circle 2 of the bottom half.

Instruction 3: The TMUL( ) instruction performs a tile multiplication to write to tile-write register, and TMUL(TW1, xx, yy) multiplies the two elements of xx and yy and writes the result to tile-write register TW1.

After context switching from Thread 1 to Thread 2, instruction 4 to 5 are executed through Thread 2.

Instruction 4: TW1=TSA(WA2) associates/assigns new context and new association of the tile-write register TW1 with the user memory address WA2.

Instruction 5: TZERO(TW1) clears the tile register data. Instruction 5 is an example of another instruction to be executed on Thread 2 to update the tile data at TW1, and additional/different instructions may update the tile data at TW1 as well.

After context switching from Thread 2 back to Thread 1, instructions 6 and 7 are executed through Thread 1.

Instruction 6: The TSTORE( ) instruction stores a tire-write register to its previous association. TSTORE(TW1) thus restores association of TW1 to user memory address WA1, the previous association. Note that TSTORE(TW1) does not take a physical address specification as the input parameter, e.g., address, stride, or flag, but instead takes a register whose context contained the appropriate user memory specification. The specified register corresponds to a virtual address associated with the thread that is being swapped in. Using the virtual address in instructions allows better flexibility and portability of the sequence of instructions. The TSTORE(TW1) operation is shown in the timeline illustration at Circle 6 of the bottom half.

Instruction 7: The TFREE( ) instruction clears the context memory specification of a register, and TFREE(TR1) clears the context memory specification of TR1.

The operations at Circles 8 and 9 in the code happen at context switching, where the former corresponds to the context switch from Thread 1 to Thread 2 and the latter from Thread 2 back to Thread 1. As shown in the timeline illustration at Circle 8, SWAP TSTORE(TW1) is a command issued by the Operating system (instead of a user instruction in the code snippet) to perform TSTORE operation during context switching from Thread 1 to Thread 2.

Similarly, SWAP TSTORE(TW1) is performed to store state of tile data of TW1 for Thread 2 at reference 9a in switching back from Thread 2 to Thread 1. Additionally, in the switching back, operation 9b reads the data from the associated read command through TRD so that the earlier stored tile data for Thread 1 is restored to TW1 and TR1.

Note that memory locations are shown in two types of lines to indicate whether a memory location has (1) stable data or (2) data that is potentially in transit. The latter in the timeline corresponds to an “active” time window where the user address space associated with a tile register is being actively used by the tile register. During this time window, the user memory space associated with the tile register content should not be modified by any user code. If this happens the result will be unpredictable as it will depend on the thread swapping behavior. Higher level software synchronization techniques can be used to sequence software operations in some embodiments, so this data hazard requirement is met. Those skilled in the art can easily propose techniques to allow visibility into the number of thread events that could possibly affect the value of the user memory space corresponding to the tile register content.

FIG. 4B illustrates context switch and corresponding state save per some embodiments. In the figure, a context switch is performed from Thread 1 (402) to Thread 2 (404), and the state save is shown using a general purpose register (GPR) 412 (e.g., including 8 bytes (8B)) and a vector register (VR) 414 (e.g., including 1,024 bytes (1 KB)) to show the contrast when state size reduction is implemented. Upon context switch, Thread 1 saves its state to the corresponding thread 1 context storage 422, which includes a memory location 1 to store the GPR value (e.g., 8B) and memory location 2 to store information to indicate where the value of VR 414 is (e.g., the information taking 16 B). In this example, the 1 KB Thread 1 VR value is stored at a memory location 432, which is associated by a user defined association. The memory location 432, identified by write address 1, may be associated with VR 414 through command TW1=TSA(WA1), and such association may be given at the initialization of VR 414 in some embodiments. In other words, Thread 1 context storage 422 stores the value of GPR value yet only the VR association information in the thread context storage 422. Thus, the context storage 422 does not need to be enlarged significantly to accommodate the 1 KB VR 414 value.

Similarly, Thread 2 (404) restores its state from Thread 2 context storage 424. It restores the 8 B GPR value stored earlier and identifies the information that indicates where to locate the 1 KB VR value for Thread 2. The information identification may be performed through the command TSTORE( ) discussed herein above and that information identifies that the 1 KB VR value is at memory location 434. In this example, the context storage destinations 420 maintain only the association information for the vector registers (or other shared resources with a large amount of values to maintain during context switching), and the association information takes much less memory storage space that the values themselves, thus these embodiments achieves state size reduction.

Note that the state size reduction discussed herein may be used in conjunction with the partial virtualization and delayed state save. The state size reduction may further reduce the impact of context switching and thus further enhance processor performance.

The performance enhancement through partial virtualization, delayed state save, and/or state size reduction can be salient in some applications including AI/ML; and the virtualization of architectural sources other than vector registers may see marked improvement as well. For example, the management of the data in the L2 cache is critical for many AI/ML applications. One may allocate part of the L2 cache to a specific AI/ML thread or different parts to different types of data in a specific thread, and leave the rest for the L2 for general use with other thread. In this case, a portion of a type of architectural sources such as the L2 cache may be assigned to the AI/ML thread while the other portion of the type of architectural resources may be virtualized and shared among the threads (sharing among all threads or among the threads other than the AI/ML thread). The partial thread virtualization may improve overall performance of the processor and/or allow AI/ML loads to be executed more efficiently.

### Operations/Apparatus in Some Embodiments

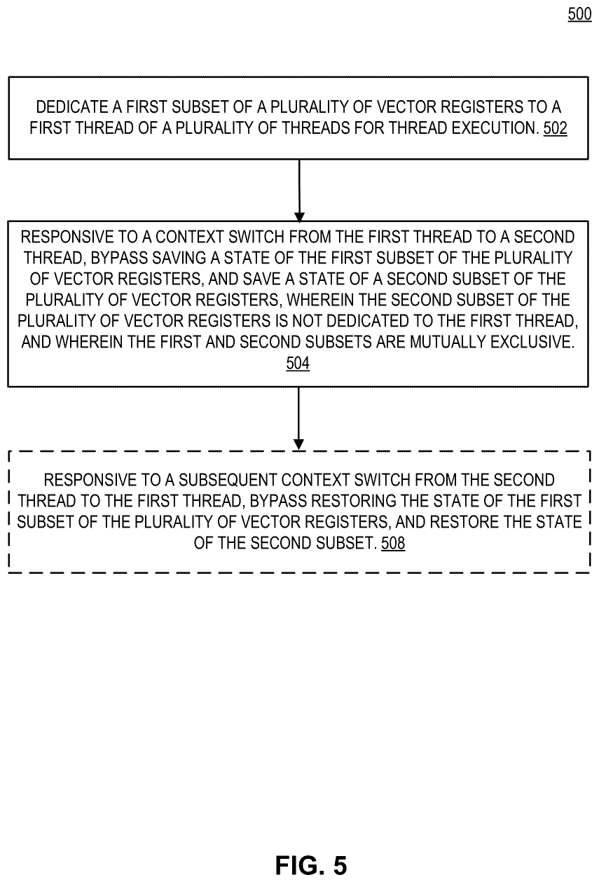

FIG. 5 illustrates a flow diagram for partial virtualization operations per some embodiments. The operations in method 500 may be performed in a processor core (e.g., processor core 102) of a computing system, where a plurality of threads is executed on a processor core within a set of processor cores of a processor. Examples of the thread execution are shown in FIG. 1 at references 144 and 146 per some embodiments.

At reference 502, a first subset of the plurality of vector registers to a first thread of the plurality of threads for thread execution. At reference 504, responsive to a context switch from the first thread to a second thread, saving a state of the first subset of the plurality of vector registers is bypassed; and a state of a second subset of the plurality of vector registers is saved, wherein the second subset of the plurality of vector registers is not dedicated to the first thread, and wherein the first and second subsets are mutually exclusive.

In some embodiments, the method further comprises responsive to a subsequent context switch from the second thread to the first thread, bypassing restoring the state of the first subset of the plurality of vector registers and restoring the state of the second subset as shown at reference 508.

In some embodiments, saving the state of the second subset of the plurality of vector registers is performed based on a detection of an access to the second subset of the plurality of vector registers by the second thread, wherein access to the second subset is then granted to the second thread. The delayed state save is discussed in more detail in the named subsection above.

In some embodiments, the detection of the access to the second subset is based on an operating system call. In some embodiments, access to the second subset is saved in a record, and wherein which vector register is to be included in the second subset in a subsequent context switch may be identified based on the record.

In some embodiments, saving the state of the second subset comprises saving information in a first memory location, the information obtained through executing a first command to associate a second memory location with the second subset, wherein the second subset is to write the state of the second subset to the second memory location. In some embodiments, the first command is TSA( ) discussed herein.

In some embodiments, the first memory location stores the state of the first thread. For example, the memory location may be context swap area discussed relating to FIG. 3 and/or the context storage destinations 420.

In some embodiments, upon a subsequent context switch to restore the first thread, the state of the second subset is restored through executing a second command to restore the state of the second subset from the second memory location, and wherein the second command uses the information saved in the first memory location that stores the state of the first thread. In some embodiments, the second command is TSTORE( ) discussed herein.

In some embodiments, during the execution of the second thread, the state of the first subset is maintained.

In some embodiments, a central processing unit (CPU), a graphics processing unit (GPU), a neural processing unit, a tensor processing unit, or a matrix math unit comprises the processor core.

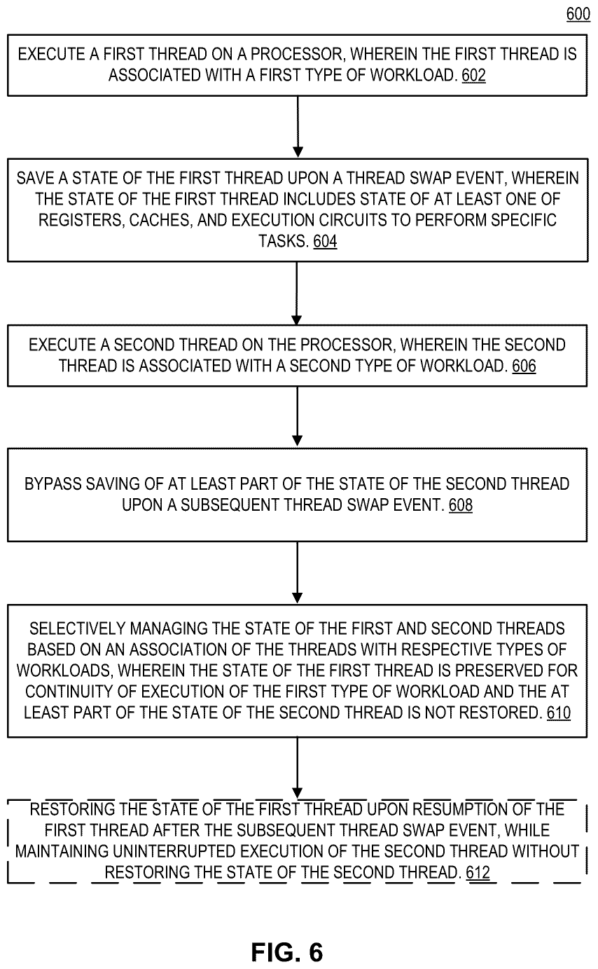

FIG. 6 illustrates a flow diagram for thread state management per some embodiments. The operations in method 600 may be performed in a processor core (e.g., processor core 102) of a computing system. The thread state management is performed in a multi-threaded processing environment on the processor core.

At reference 602, a first thread is executed on a processor, where the first thread is associated with a first type of workload. At reference 604, a state of the first thread is saved upon a thread swap event, wherein the state of the first thread includes state of at least one of registers, caches, and execution circuits to perform specific tasks. At reference 606, a second thread is executed on the processor, wherein the second thread is associated with a second type of workload. At reference 608, saving of at least part of the state of the second thread is bypassed upon a subsequent thread swap event. At reference 610, the state of the first and second threads is managed based on an association of the threads with respective types of workloads, wherein the state of the first thread is preserved for continuity of execution of the first type of workload and the at least part of the state of the second thread is not restored.

The at least part of the state includes the state of architectural resources that is partially saved or saved with delay during a context switch, and the state of architectural resources comprises one or more commands to store or reload the content of the one or more architectural resources, instead of the content itself. Note that with bypassing at least part of the state of the second thread, the second thread in method 600 is similar to the first thread in method 500 in that both implement partial state save. The operations done on the first thread in method 500 may thus be performed on the second thread in method 600.

In some embodiments, the first type of workload is a shorter thread, and the second type of workload is a longer thread such as ones for AI/ML tasks/applications.

In some embodiments, the processor comprises logic configured to determine whether a thread is associated with the second type of workload and to control the saving and bypassing of a state of the thread accordingly. For example, the control unit may be thread control 1601 shown in FIG. 16.

In some embodiments, bypassing the saving of at least part of the state of the second thread includes maintaining a state of registers specific to the second thread (e.g., operational state within the corresponding on-chip registers including vector registers) during execution. In some embodiments, the on-chip registers include vector registers discussed herein.

In some embodiments, method 600 further comprises restoring the state of the first thread upon resumption of the first thread after the subsequent thread swap event, while maintaining uninterrupted execution of the second thread without restoring the state of the second thread as shown at reference 612. The second thread may be executed uninterrupted without restoring the partial/full state as the first thread does not use the corresponding resources such as the architectural resources discussed herein, and the state of the architectural resources, as part of the state of the second thread, is bypassed in the subsequent thread swap event.

In some embodiments, the second type of workload includes tasks selected from a group consisting of machine learning algorithms, neural network processing, and data analytics.

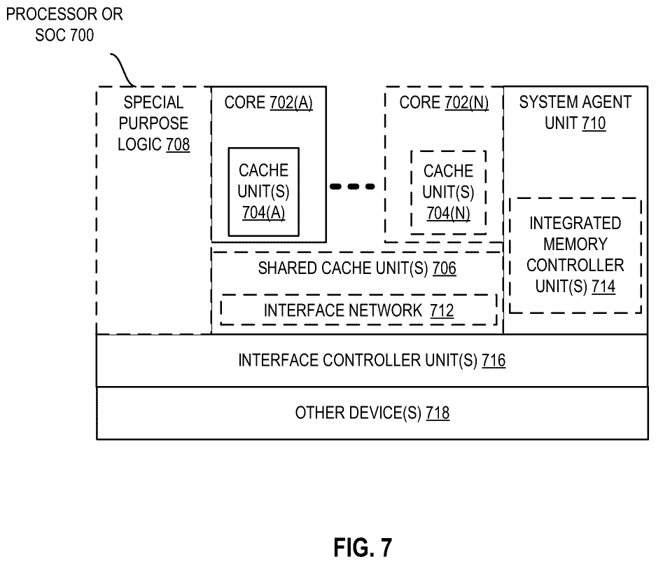

FIG. 7 illustrates a processor with a set of cores and resources for thread execution per some embodiments. Processor or system on a chip (SoC) 700 includes a set of cores such as cores 702(A) to 702(N). The set of cores may be configured to execute threads, and resources are assigned to the threads for thread execution, where execution of a first thread and a second thread on a core of the set of processor core is to virtualize a first set of resources for the first and second threads while assigning a second set of resources to the first thread. The resources are architectural resources discussed herein.

In some embodiments, the thread execution on the core comprises upon a first context switch off the first thread, bypassing saving a state of the first set of resources for the first thread; and upon a second context switch to the first thread, bypassing restoring s state of the first set of resources for the first thread.

In some embodiments, the thread execution on the processor core comprises upon a context switch from the first thread to the second thread, a state of the second set of resources is saved for the first thread at a later time after the context switch upon a detection of an access request or an access attempt of the second set of resources by the second thread, wherein access to the second set of resources is then granted to the second thread.

In some embodiments, the state of the second set of resources is saved for the first thread through executing a first command to save the state of the second set of resources for the first thread to a user space memory location.

Additionally/alternatively, wherein upon a subsequent context switch to restore the first thread, the state of the second set of resources for the first thread is restored through executing a second command to restore the state of the second set of resources from the user space memory location, wherein information necessary to restore the state of the second set of resources including the second command is saved in the memory location that stores the state of the first thread.

Note that processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

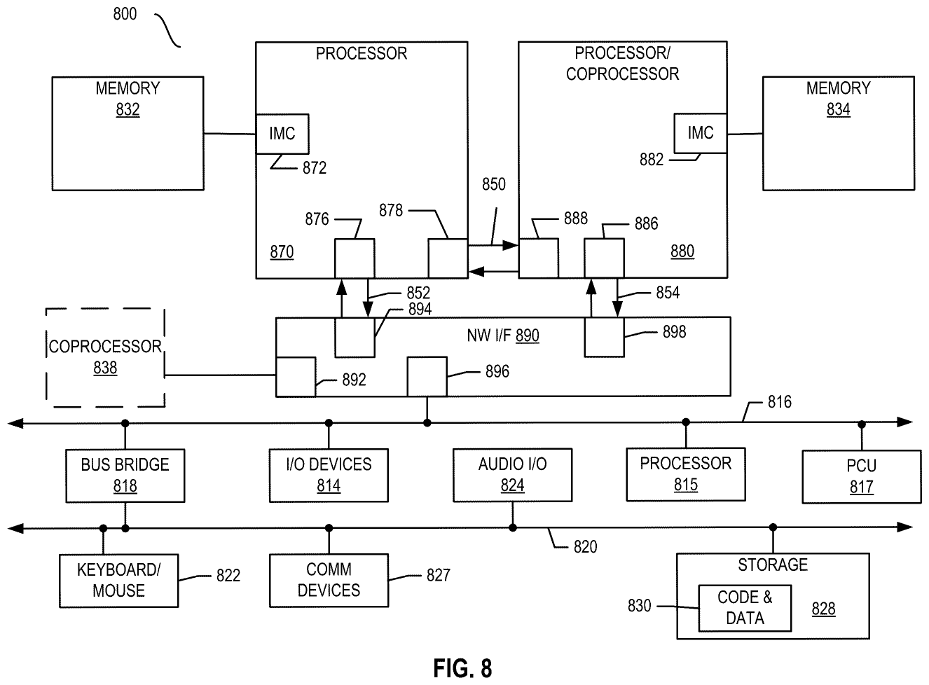

In FIG. 7, the solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 870 or 880, or coprocessor 838 or 815 of FIG. 8.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller units circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

FIG. 8 illustrates an example computing system. Multiprocessor system 800 is an interfaced system and includes a plurality of processors or cores including a first processor 870 and a second processor 880 coupled via an interface 850 such as a point-to-point (P-P) interconnect, a fabric, and/or bus. In some examples, the first processor 870 and the second processor 880 are homogeneous. In some examples, the first processor 870 and the second processor 880 are heterogenous. Though the example system 800 is shown to have two processors, the system may have three or more processors, or may be a single processor system. In some examples, the computing system is a system on a chip (SoC).

Processors 870 and 880 are shown including integrated memory controller (IMC) circuitry 872 and 882, respectively. Processor 870 also includes interface circuits 876 and 878; similarly, second processor 880 includes interface circuits 886 and 888. Processors 870, 880 may exchange information via the interface 850 using interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of an interconnect, bus, mesh, and/or fabric, and in some examples is a chipset) may optionally exchange information with a coprocessor 838 via an interface circuit 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via an interface such as P-P interconnect, such that either or both processors' local cache information may be stored in the shared cache if a processor is placed into a low power mode.

Network interface 890 may be coupled to a first interface 816 via interface circuit 896. In some examples, first interface 816 may be an interface such as a Peripheral Component Interconnect Express (PCI) interconnect, a PCI Express (PCIe) interconnect, Compute Express Link (CXL), NVLink, HyperTransport, or another I/O interconnect. In some examples, first interface 816 is coupled to a power control unit (PCU) 817, which may include circuitry, software, and/or firmware to perform power management operations with regard to the processors 870, 880 and/or coprocessor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interface 816, along with a bus bridge 818 which couples first interface 816 to a second interface 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface. Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830 and may implement the storage 'ISAB03 in some examples. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

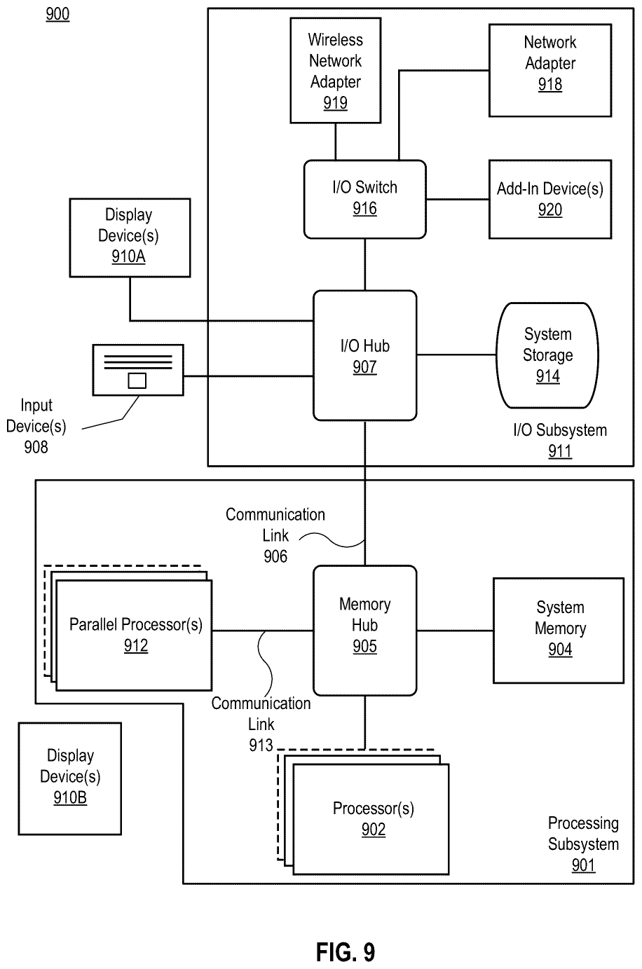

FIG. 9 is a block diagram illustrating a computing system 900 configured to implement one or more aspects of the examples described herein. The computing system 900 includes a processing subsystem 901 having one or more processor(s) 902 and a system memory 904 communicating via an interconnection path that may include a memory hub 905. The memory hub 905 may be a separate component within a chipset component or may be integrated within the one or more processor(s) 902. The memory hub 905 couples with an I/O subsystem 911 via a communication link 906. The I/O subsystem 911 includes an I/O hub 907 that can enable the computing system 900 to receive input from one or more input device(s) 908. Additionally, the I/O hub 907 can enable a display controller, which may be included in the one or more processor(s) 902, to provide outputs to one or more display device(s) 910A. In some examples the one or more display device(s) 910A coupled with the I/O hub 907 can include a local, internal, or embedded display device.

The processing subsystem 901, for example, includes one or more parallel processor(s) 912 coupled to memory hub 905 via a bus or other communication link 913. The communication link 913 may be one of any number of standards-based communication link technologies or protocols, such as, but not limited to PCI Express, or may be a vendor specific communications interface or communications fabric. The one or more parallel processor(s) 912 may form a computationally focused parallel or vector processing system that can include a large number of processing cores and/or processing clusters, such as a many integrated core (MIC) processor. For example, the one or more parallel processor(s) 912 form a graphics processing subsystem that can output pixels to one of the one or more display device(s) 910A coupled via the I/O hub 907. The one or more parallel processor(s) 912 can also include a display controller and display interface (not shown) to enable a direct connection to one or more display device(s) 910B.

Within the I/O subsystem 911, a system storage unit 914 can connect to the I/O hub 907 to provide a storage mechanism for the computing system 900. An I/O switch 916 can be used to provide an interface mechanism to enable connections between the I/O hub 907 and other components, such as a network adapter 918 and/or wireless network adapter 919 that may be integrated into the platform, and various other devices that can be added via one or more add-in device(s) 920. The add-in device(s) 920 may also include, for example, one or more external graphics processor devices, graphics cards, and/or compute accelerators. The network adapter 918 can be an Ethernet adapter or another wired network adapter. The wireless network adapter 919 can include one or more of a Wi-Fi, Bluetooth, near field communication (NFC), or other network device that includes one or more wireless radios.

The computing system 900 can include other components not explicitly shown, including USB or other port connections, optical storage drives, video capture devices, and the like, which may also be connected to the I/O hub 907. Communication paths interconnecting the various components in FIG. 9 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Universal Chiplet Interconnect Express (UCIe), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 912 may incorporate circuitry optimized for graphics and video processing, including, for example, video output circuitry, and constitutes a graphics processing unit (GPU). Alternatively or additionally, the one or more parallel processor(s) 912 can incorporate circuitry optimized for general purpose processing, while preserving the underlying computational architecture, described in greater detail herein. Components of the computing system 900 may be integrated with one or more other system elements on a single integrated circuit. For example, the one or more parallel processor(s) 912, memory hub 905, processor(s) 902, and I/O hub 907 can be integrated into a system on chip (SoC) integrated circuit. Alternatively, the components of the computing system 900 can be integrated into a single package to form a system in package (SIP) configuration. In some examples at least a portion of the components of the computing system 900 can be integrated into a multi-chip module (MCM), which can be interconnected with other multi-chip modules into a modular computing system.

It will be appreciated that the computing system 900 shown herein is illustrative and that variations and modifications are possible. The connection topology, including the number and arrangement of bridges, the number of processor(s) 902, and the number of parallel processor(s) 912, may be modified as desired. For instance, system memory 904 can be connected to the processor(s) 902 directly rather than through a bridge, while other devices communicate with system memory 904 via the memory hub 905 and the processor(s) 902. In other alternative topologies, the parallel processor(s) 912 are connected to the I/O hub 907 or directly to one of the one or more processor(s) 902, rather than to the memory hub 905. In other examples, the I/O hub 907 and memory hub 905 may be integrated into a single chip. It is also possible that two or more sets of processor(s) 902 are attached via multiple sockets, which can couple with two or more instances of the parallel processor(s) 912.

Some of the particular components shown herein are optional and may not be included in all implementations of the computing system 900. For example, any number of add-in cards or peripherals may be supported, or some components may be eliminated. Furthermore, some architectures may use different terminology for components similar to those illustrated in FIG. 9. For example, the memory hub 905 may be referred to as a Northbridge in some architectures, while the I/O hub 907 may be referred to as a Southbridge.

Detailed below are further descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices are also suitable. In general, a variety of systems or electronic devices capable of incorporating a processor and/or other execution logic as disclosed herein are generally suitable, and the embodiments are not limited to these exemplary systems and processors.

### Further Example Systems

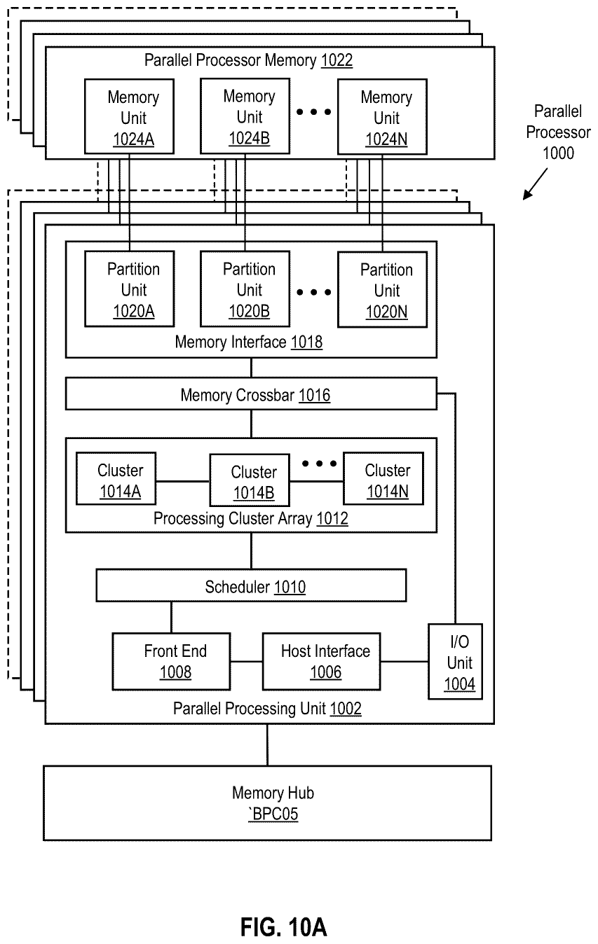

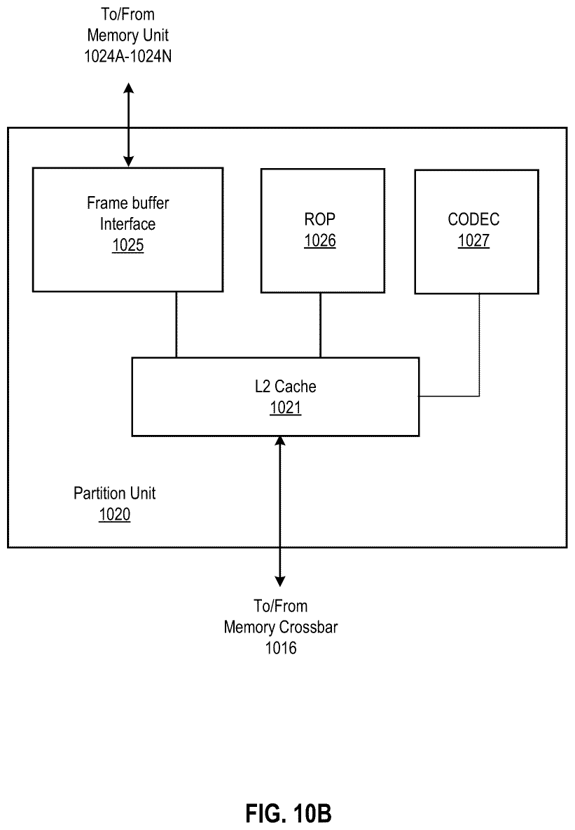

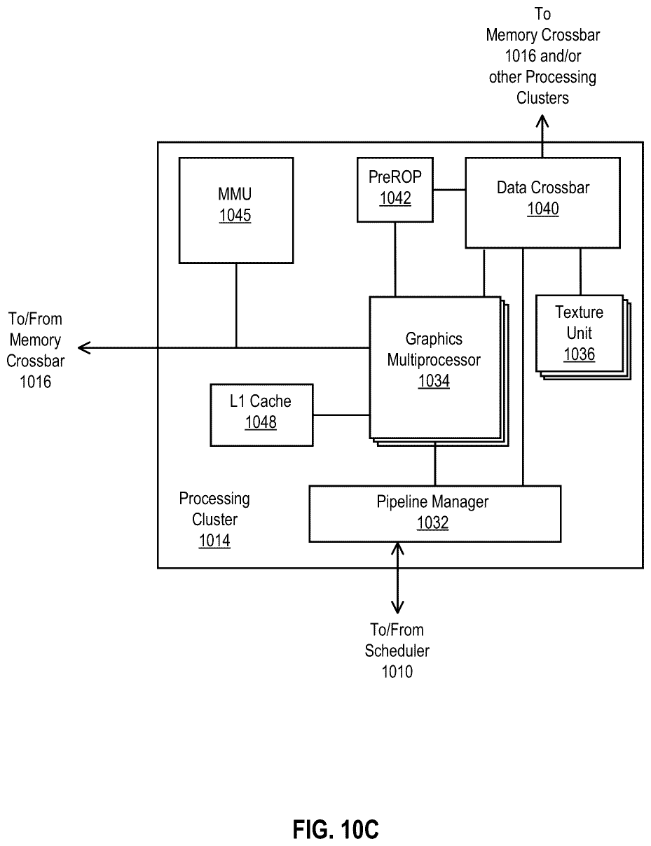

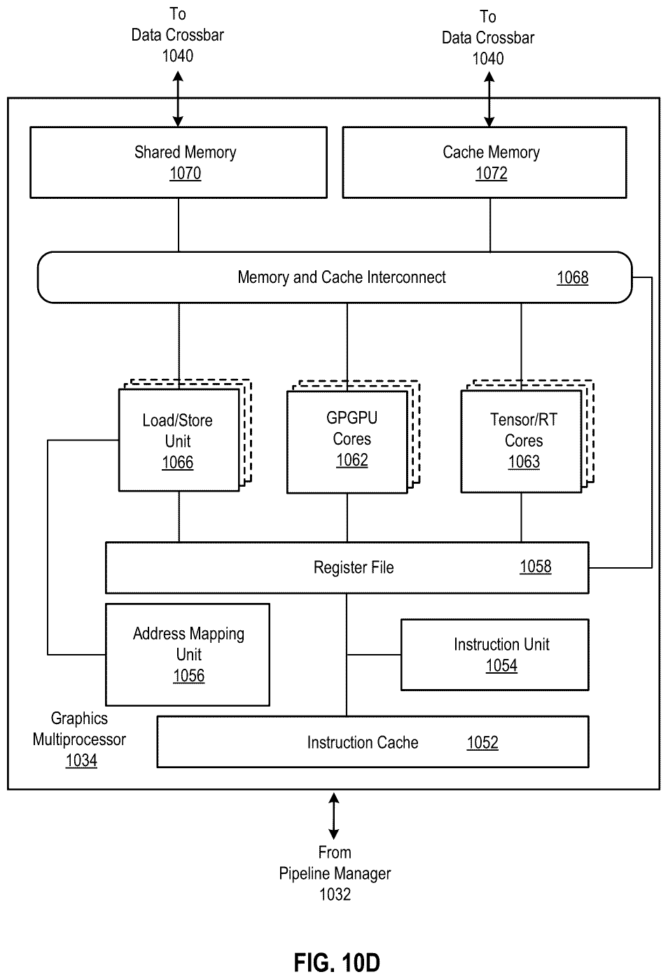

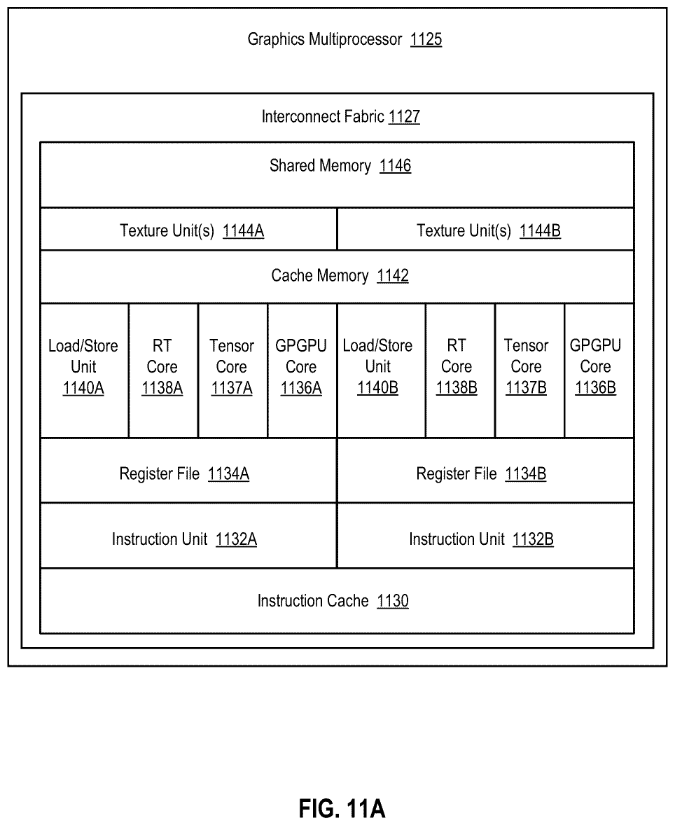

FIG. 10A illustrates examples of a parallel processor 1000. The parallel processor 1000 may be a GPU, GPGPU or the like as described herein. The various components of the parallel processor 1000 may be implemented using one or more integrated circuit devices, such as programmable processors, application specific integrated circuits (ASICs), or field programmable gate arrays (FPGA). The illustrated parallel processor 1000 may be one or more of the parallel processor(s) 912 shown in FIG. 9.

The parallel processor 1000 includes a parallel processing unit 1002. The parallel processing unit includes an I/O unit 1004 that enables communication with other devices, including other instances of the parallel processing unit 1002. The I/O unit 1004 may be directly connected to other devices. For instance, the I/O unit 1004 connects with other devices via the use of a hub or switch interface, such as memory hub 1005. The connections between the memory hub 1005 and the I/O unit 1004 form a communication link 913. Within the parallel processing unit 1002, the I/O unit 1004 connects with a host interface 1006 and a memory crossbar 1016, where the host interface 1006 receives commands directed to performing processing operations and the memory crossbar 1016 receives commands directed to performing memory operations.

When the host interface 1006 receives a command buffer via the I/O unit 1004, the host interface 1006 can direct work operations to perform those commands to a front end 1008. In some examples the front end 1008 couples with a scheduler 1010, which is configured to distribute commands or other work items to a processing cluster array 1012. The scheduler 1010 ensures that the processing cluster array 1012 is properly configured and in a valid state before tasks are distributed to the processing clusters of the processing cluster array 1012. The scheduler 1010 may be implemented via firmware logic executing on a microcontroller. The microcontroller implemented scheduler 1010 is configurable to perform complex scheduling and work distribution operations at coarse and fine granularity, enabling rapid preemption and context switching of threads executing on the processing cluster array 1012. Preferably, the host software can prove workloads for scheduling on the processing cluster array 1012 via one of multiple graphics processing doorbells. In other examples, polling for new workloads or interrupts can be used to identify or indicate availability of work to perform. The workloads can then be automatically distributed across the processing cluster array 1012 by the scheduler 1010 logic within the scheduler microcontroller.

The processing cluster array 1012 can include up to “N” processing clusters (e.g., cluster 1014A, cluster 1014B, through cluster 1014N). Each cluster 1014A-1014N of the processing cluster array 1012 can execute a large number of concurrent threads. The scheduler 1010 can allocate work to the clusters 1014A-1014N of the processing cluster array 1012 using various scheduling and/or work distribution algorithms, which may vary depending on the workload arising for each type of program or computation. The scheduling can be handled dynamically by the scheduler 1010 or can be assisted in part by compiler logic during compilation of program logic configured for execution by the processing cluster array 1012. Optionally, different clusters 1014A-1014N of the processing cluster array 1012 can be allocated for processing different types of programs or for performing different types of computations.

The processing cluster array 1012 can be configured to perform various types of parallel processing operations. For example, the processing cluster array 1012 is configured to perform general-purpose parallel compute operations. For example, the processing cluster array 1012 can include logic to execute processing tasks including filtering of video and/or audio data, performing modeling operations, including physics operations, and performing data transformations.

The processing cluster array 1012 is configured to perform parallel graphics processing operations. In such examples in which the parallel processor 1000 is configured to perform graphics processing operations, the processing cluster array 1012 can include additional logic to support the execution of such graphics processing operations, including, but not limited to texture sampling logic to perform texture operations, as well as tessellation logic and other vertex processing logic. Additionally, the processing cluster array 1012 can be configured to execute graphics processing related shader programs such as, but not limited to vertex shaders, tessellation shaders, geometry shaders, and pixel shaders. The parallel processing unit 1002 can transfer data from system memory via the I/O unit 1004 for processing. During processing the transferred data can be stored to on-chip memory (e.g., parallel processor memory 1022) during processing, then written back to system memory.

In examples in which the parallel processing unit 1002 is used to perform graphics processing, the scheduler 1010 may be configured to divide the processing workload into approximately equal sized tasks, to better enable distribution of the graphics processing operations to multiple clusters 1014A-1014N of the processing cluster array 1012. In some of these examples, portions of the processing cluster array 1012 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 1014A-1014N may be stored in buffers to allow the intermediate data to be transmitted between clusters 1014A-1014N for further processing.

During operation, the processing cluster array 1012 can receive processing tasks to be executed via the scheduler 1010, which receives commands defining processing tasks from front end 1008. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 1010 may be configured to fetch the indices corresponding to the tasks or may receive the indices from the front end 1008. The front end 1008 can be configured to ensure the processing cluster array 1012 is configured to a valid state before the workload specified by incoming command buffers (e.g., batch-buffers, push buffers, etc.) is initiated.

Each of the one or more instances of the parallel processing unit 1002 can couple with parallel processor memory 1022. The parallel processor memory 1022 can be accessed via the memory crossbar 1016, which can receive memory requests from the processing cluster array 1012 as well as the I/O unit 1004. The memory crossbar 1016 can access the parallel processor memory 1022 via a memory interface 1018. The memory interface 1018 can include multiple partition units (e.g., partition unit 1020A, partition unit 1020B, through partition unit 1020N) that can each couple to a portion (e.g., memory unit) of parallel processor memory 1022. The number of partition units 1020A-1020N may be configured to be equal to the number of memory units, such that a first partition unit 1020A has a corresponding first memory unit 1024A, a second partition unit 1020B has a corresponding second memory unit 1024B, and an Nth partition unit 1020N has a corresponding Nth memory unit 1024N. In other examples, the number of partition units 1020A-1020N may not be equal to the number of memory devices.

The memory units 1024A-1024N can include various types of memory devices, including dynamic random-access memory (DRAM) or graphics random access memory, such as synchronous graphics random access memory (SGRAM), including graphics double data rate (GDDR) memory. Optionally, the memory units 1024A-1024N may also include 3D stacked memory, including but not limited to high bandwidth memory (HBM). Persons skilled in the art will appreciate that the specific implementation of the memory units 1024A-1024N can vary and can be selected from one of various conventional designs. Render targets, such as frame buffers or texture maps may be stored across the memory units 1024A-1024N, allowing partition units 1020A-1020N to write portions of each render target in parallel to efficiently use the available bandwidth of parallel processor memory 1022. In some examples, a local instance of the parallel processor memory 1022 may be excluded in favor of a unified memory design that utilizes system memory in conjunction with local cache memory.

Optionally, any one of the clusters 1014A-1014N of the processing cluster array 1012 has the ability to process data that will be written to any of the memory units 1024A-1024N within parallel processor memory 1022. The memory crossbar 1016 can be configured to transfer the output of each cluster 1014A-1014N to any partition unit 1020A-1020N or to another cluster 1014A-1014N, which can perform additional processing operations on the output. Each cluster 1014A-1014N can communicate with the memory interface 1018 through the memory crossbar 1016 to read from or write to various external memory devices. In one of the examples with the memory crossbar 1016 the memory crossbar 1016 has a connection to the memory interface 1018 to communicate with the I/O unit 1004, as well as a connection to a local instance of the parallel processor memory 1022, enabling the processing units within the different processing clusters 1014A-1014N to communicate with system memory or other memory that is not local to the parallel processing unit 1002. Generally, the memory crossbar 1016 may, for example, be able to use virtual channels to separate traffic streams between the clusters 1014A-1014N and the partition units 1020A-1020N.

While a single instance of the parallel processing unit 1002 is illustrated within the parallel processor 1000, any number of instances of the parallel processing unit 1002 can be included. For example, multiple instances of the parallel processing unit 1002 can be provided on a single add-in card, or multiple add-in cards can be interconnected. For example, the parallel processor 1000 can be an add-in device, such as add-in device 920 of FIG. 9, which may be a graphics card such as a discrete graphics card that includes one or more GPUs, one or more memory devices, and device-to-device or network or fabric interfaces. The different instances of the parallel processing unit 1002 can be configured to inter-operate even if the different instances have different numbers of processing cores, different amounts of local parallel processor memory, and/or other configuration differences. Optionally, some instances of the parallel processing unit 1002 can include higher precision floating point units relative to other instances. Systems incorporating one or more instances of the parallel processing unit 1002 or the parallel processor 1000 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 1002 can be partitioned into multiple instances. Those multiple instances can be configured to execute workloads associated with different clients in an isolated manner, enabling a pre-determined quality of service to be provided for each client. For example, each cluster 1014A-1014N can be compartmentalized and isolated from other clusters, allowing the processing cluster array 1012 to be divided into multiple compute partitions or instances. In such configuration, workloads that are executed on an isolated partition are protected from faults or errors associated with a different workload that is executed on a different partition. The partition units 1020A-1020N can be configured to enable a dedicated and/or isolated path to memory for the clusters 1014A-1014N associated with the respective compute partitions. This datapath isolation enables the compute resources within a partition can communicate with one or more assigned memory units 1024A-1024N without being subjected to inference by the activities of other partitions.

FIG. 10B is a block diagram of a partition unit 1020. The partition unit 1020 may be an instance of one of the partition units 1020A-1020N of FIG. 10A. As illustrated, the partition unit 1020 includes an L2 cache 1021, a frame buffer interface 1025, and a ROP 1026 (raster operations unit). The L2 cache 1021 is a read/write cache that is configured to perform load and store operations received from the memory crossbar 1016 and ROP 1026. Read misses and urgent write-back requests are output by L2 cache 1021 to frame buffer interface 1025 for processing. Updates can also be sent to the frame buffer via the frame buffer interface 1025 for processing. In some examples the frame buffer interface 1025 interfaces with one of the memory units 1024 in parallel processor memory, such as the memory units 1024A-1024N of FIG. 10A (e.g., within parallel processor memory 1022). The partition unit 1020 may additionally or alternatively also interface with one of the memory units in parallel processor memory via a memory controller (not shown).

In graphics applications, the ROP 1026 is a processing unit that performs raster operations such as stencil, z test, blending, and the like. The ROP 1026 then outputs processed graphics data that is stored in graphics memory. In some examples the ROP 1026 includes or couples with a CODEC 1027 that includes compression logic to compress depth or color data that is written to memory or the L2 cache 1021 and decompress depth or color data that is read from memory or the L2 cache 1021. The compression logic can be lossless compression logic that makes use of one or more of multiple compression algorithms. The type of compression that is performed by CODEC 1027 can vary based on the statistical characteristics of the data to be compressed. For example, in some examples, delta color compression is performed on depth and color data on a per-tile basis. In some examples, CODEC 1027 includes compression and decompression logic that can compress and decompress compute data associated with machine learning operations. CODEC 1027 can, for example, compress sparse matrix data for sparse machine learning operations. CODEC 1027 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

ROP 1026 may be included within each processing cluster (e.g., cluster 1014A-1014N of FIG. 10A) instead of within the partition unit 1020. In such an example, read and write requests for pixel data are transmitted over the memory crossbar 1016 instead of pixel fragment data. The processed graphics data may be displayed on a display device, such as one of the one or more display device(s) 910A-910B of FIG. 9, routed for further processing by the processor(s) 902, or routed for further processing by one of the processing entities within the parallel processor 1000 of FIG. 10A.

FIG. 10C is a block diagram of a processing cluster 1014 within a parallel processing unit. For example, the processing cluster is an instance of one of the processing clusters 1014A-1014N of FIG. 10A. The processing cluster 1014 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to follow divergent execution paths readily through a given thread program. Persons skilled in the art will understand that a SIMD processing regime represents a functional subset of a SIMT processing regime.

Operation of the processing cluster 1014 can be controlled via a pipeline manager 1032 that distributes processing tasks to SIMT parallel processors. The pipeline manager 1032 receives instructions from scheduler 1010 of FIG. 10A and manages execution of those instructions via a graphics multiprocessor 1034 and/or a texture unit 1036. The illustrated graphics multiprocessor 1034 is an exemplary instance of a SIMT parallel processor. However, various types of SIMT parallel processors of differing architectures may be included within the processing cluster 1014. One or more instances of the graphics multiprocessor 1034 can be included within a processing cluster 1014. The graphics multiprocessor 1034 can process data and a data crossbar 1040 can be used to distribute the processed data to one of multiple possible destinations, including other shader units. The pipeline manager 1032 can facilitate the distribution of processed data by specifying destinations for processed data to be distributed via the data crossbar 1040.

Each graphics multiprocessor 1034 within the processing cluster 1014 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 1014 constitute a thread. A set of threads executing across the set of parallel processing engines is a thread group. A thread group executes the same program on different input data. Each thread within a thread group can be assigned to a different processing engine within a graphics multiprocessor 1034. A thread group may include fewer threads than the number of processing engines within the graphics multiprocessor 1034. When a thread group includes fewer threads than the number of processing engines, one or more of the processing engines may be idle during cycles in which that thread group is being processed. A thread group may also include more threads than the number of processing engines within the graphics multiprocessor 1034. When the thread group includes more threads than the number of processing engines within the graphics multiprocessor 1034, processing can be performed over consecutive clock cycles. Optionally, multiple thread groups can be executed concurrently on graphics multiprocessor 1034.

The graphics multiprocessor 1034 may include an internal cache memory to perform load and store operations. Optionally, the graphics multiprocessor 1034 can forego an internal cache and use a cache memory (e.g., level 1 (L1) cache 1048) within the processing cluster 1014. Each graphics multiprocessor 1034 also has access to level 2 (L2) caches within the partition units (e.g., partition units 1020A-1020N of FIG. 10A) that are shared among all processing clusters 1014 and may be used to transfer data between threads. The graphics multiprocessor 1034 may also access off-chip global memory, which can include one or more of local parallel processor memory and/or system memory. Any memory external to the parallel processing unit 1002 may be used as global memory. Embodiments in which the processing cluster 1014 includes multiple instances of the graphics multiprocessor 1034 can share common instructions and data, which may be stored in the L1 cache 1048.

Each processing cluster 1014 may include an MMU 1045 (memory management unit) that is configured to map virtual addresses into physical addresses. In other examples, one or more instances of the MMU 1045 may reside within the memory interface 1018 of FIG. 10A. The MMU 1045 includes a set of page table entries (PTEs) used to map a virtual address to a physical address of a tile and optionally a cache line index. The MMU 1045 may include address translation lookaside buffers (TLB) or caches that may reside within the graphics multiprocessor 1034 or the L1 cache 1048 of processing cluster 1014. The physical address is processed to distribute surface data access locality to allow efficient request interleaving among partition units. The cache line index may be used to determine whether a request for a cache line is a hit or miss.

In graphics and computing applications, a processing cluster 1014 may be configured such that each graphics multiprocessor 1034 is coupled to a texture unit 1036 for performing texture mapping operations, e.g., determining texture sample positions, reading texture data, and filtering the texture data. Texture data is read from an internal texture L1 cache (not shown) or in some examples from the L1 cache within graphics multiprocessor 1034 and is fetched from an L2 cache, local parallel processor memory, or system memory, as needed. Each graphics multiprocessor 1034 outputs processed tasks to the data crossbar 1040 to provide the processed task to another processing cluster 1014 for further processing or to store the processed task in an L2 cache, local parallel processor memory, or system memory via the memory crossbar 1016. A preROP 1042 (pre-raster operations unit) is configured to receive data from graphics multiprocessor 1034, direct data to ROP units, which may be located with partition units as described herein (e.g., partition units 1020A-1020N of FIG. 10A). The preROP 1042 unit can perform optimizations for color blending, organize pixel color data, and perform address translations.

It will be appreciated that the core architecture described herein is illustrative and that variations and modifications are possible. Any number of processing units, e.g., graphics multiprocessor 1034, texture units 1036, preROPs 1042, etc., may be included within a processing cluster 1014. Further, while only one processing cluster 1014 is shown, a parallel processing unit as described herein may include any number of instances of the processing cluster 1014. Optionally, each processing cluster 1014 can be configured to operate independently of other processing clusters 1014 using separate and distinct processing units, L1 caches, L2 caches, etc.

FIG. 10D shows an example of graphics multiprocessor 1034 in which the graphics multiprocessor 1034 couples with the pipeline manager 1032 of the processing cluster 1014. The graphics multiprocessor 1034 has an execution pipeline including but not limited to an instruction cache 1052, an instruction unit 1054, an address mapping unit 1056, a register file 1058, one or more general purpose graphics processing unit (GPGPU) cores 1062, and one or more load/store units 1066. The GPGPU cores 1062 and load/store units 1066 are coupled with cache memory 1072 and shared memory 1070 via a memory and cache interconnect 1068. The graphics multiprocessor 1034 may additionally include tensor and/or ray-tracing cores 1063 that include hardware logic to accelerate matrix and/or ray-tracing operations.

The instruction cache 1052 may receive a stream of instructions to execute from the pipeline manager 1032. The instructions are cached in the instruction cache 1052 and dispatched for execution by the instruction unit 1054. The instruction unit 1054 can dispatch instructions as thread groups (e.g., warps), with each thread of the thread group assigned to a different execution unit within GPGPU core 1062. An instruction can access any of a local, shared, or global address space by specifying an address within a unified address space. The address mapping unit 1056 can be used to translate addresses in the unified address space into a distinct memory address that can be accessed by the load/store units 1066.

The register file 1058 provides a set of registers for the functional units of the graphics multiprocessor 1034. The register file 1058 provides temporary storage for operands connected to the data paths of the functional units (e.g., GPGPU cores 1062, load/store units 1066) of the graphics multiprocessor 1034. The register file 1058 may be divided between each of the functional units such that each functional unit is allocated a dedicated portion of the register file 1058. For example, the register file 1058 may be divided between the different warps being executed by the graphics multiprocessor 1034.

The GPGPU cores 1062 can each include floating point units (FPUs) and/or integer arithmetic logic units (ALUs) that are used to execute instructions of the graphics multiprocessor 1034. In some implementations, the GPGPU cores 1062 can include hardware logic that may otherwise reside within the tensor and/or ray-tracing cores 1063. The GPGPU cores 1062 can be similar in architecture or can differ in architecture. For example and in some examples, a first portion of the GPGPU cores 1062 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 1034 can additionally include one or more fixed function or special function units to perform specific functions such as copy rectangle or pixel blending operations. One or more of the GPGPU cores can also include fixed or special function logic.

The GPGPU cores 1062 may include SIMD logic capable of performing a single instruction on multiple sets of data. Optionally, GPGPU cores 1062 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 1068 is an interconnect network that connects each of the functional units of the graphics multiprocessor 1034 to the register file 1058 and to the shared memory 1070. For example, the memory and cache interconnect 1068 is a crossbar interconnect that allows the load/store unit 1066 to implement load and store operations between the shared memory 1070 and the register file 1058. The register file 1058 can operate at the same frequency as the GPGPU cores 1062, thus data transfer between the GPGPU cores 1062 and the register file 1058 is very low latency. The shared memory 1070 can be used to enable communication between threads that execute on the functional units within the graphics multiprocessor 1034. The cache memory 1072 can be used as a data cache for example, to cache texture data communicated between the functional units and the texture unit 1036. The shared memory 1070 can also be used as a program managed cached. The shared memory 1070 and the cache memory 1072 can couple with the data crossbar 1040 to enable communication with other components of the processing cluster. Threads executing on the GPGPU cores 1062 can programmatically store data within the shared memory in addition to the automatically cached data that is stored within the cache memory 1072.

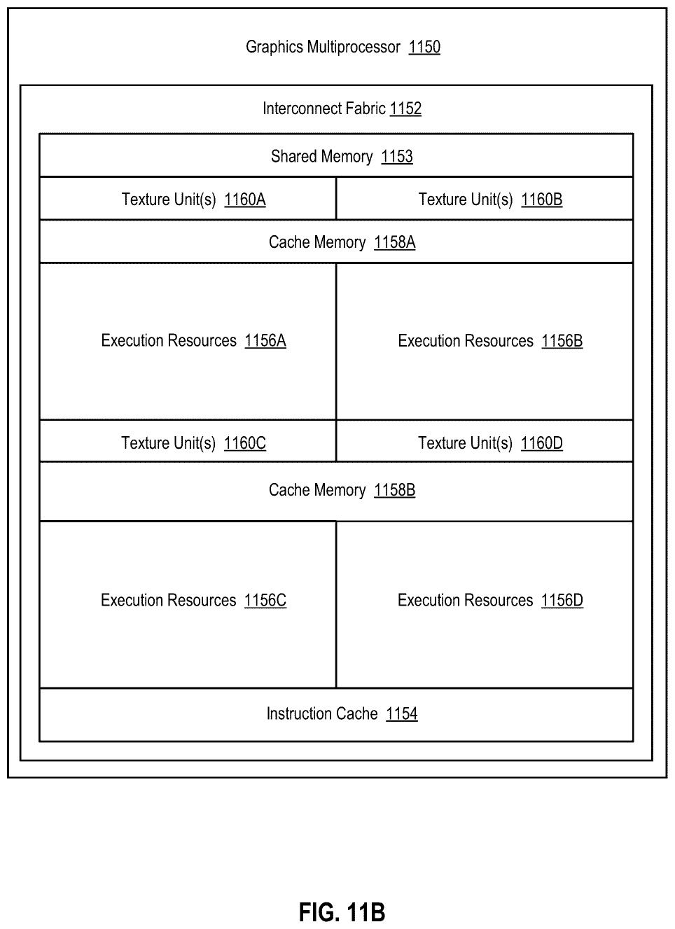

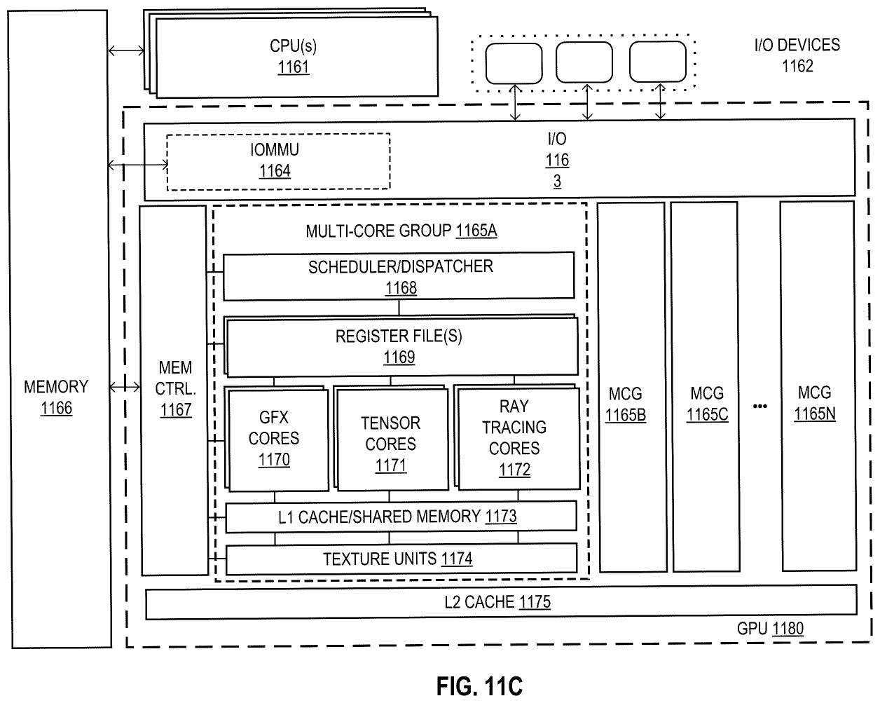

FIGS. 11A-11C illustrate additional graphics multiprocessors, according to examples. FIGS. 11A-11B illustrate graphics multiprocessors 1125, 1150, which are related to the graphics multiprocessor 1034 of FIG. 10C and may be used in place of one of those. Therefore, the disclosure of any features in combination with the graphics multiprocessor 1034 herein also discloses a corresponding combination with the graphics multiprocessor(s) 1125, 1150, but is not limited to such. FIG. 11C illustrates a graphics processing unit (GPU) 1180 which includes dedicated sets of graphics processing resources arranged into multi-core groups 1165A-1165N, which correspond to the graphics multiprocessors 1125, 1150. The illustrated graphics multiprocessors 1125, 1150 and the multi-core groups 1165A-1165N can be streaming multiprocessors (SM) capable of simultaneous execution of a large number of execution threads.

The graphics multiprocessor 1125 of FIG. 11A includes multiple additional instances of execution resource units relative to the graphics multiprocessor 1034 of FIG. 10D. For example, the graphics multiprocessor 1125 can include multiple instances of the instruction unit 1132A-1132B, register file 1134A-1134B, and texture unit(s) 1144A-1144B. The graphics multiprocessor 1125 also includes multiple sets of graphics or compute execution units (e.g., GPGPU core 1136A-1136B, tensor core 1137A-1137B, ray-tracing core 1138A-1138B) and multiple sets of load/store units 1140A-1140B. The execution resource units have a common instruction cache 1130, texture and/or data cache memory 1142, and shared memory 1146.

The various components can communicate via an interconnect fabric 1127. The interconnect fabric 1127 may include one or more crossbar switches to enable communication between the various components of the graphics multiprocessor 1125. The interconnect fabric 1127 may be a separate, high-speed network fabric layer upon which each component of the graphics multiprocessor 1125 is stacked. The components of the graphics multiprocessor 1125 communicate with remote components via the interconnect fabric 1127. For example, the cores 1136A-1136B, 1137A-1137B, and 1138A-1138B can each communicate with shared memory 1146 via the interconnect fabric 1127. The interconnect fabric 1127 can arbitrate communication within the graphics multiprocessor 1125 to ensure a fair bandwidth allocation between components.

The graphics multiprocessor 1150 of FIG. 11B includes multiple sets of execution resources 1156A-1156D, where each set of execution resource includes multiple instruction units, register files, GPGPU cores, and load store units, as illustrated in FIG. 10D and FIG. 11A. The execution resources 1156A-1156D can work in concert with texture unit(s) 1160A-1160D for texture operations, while sharing an instruction cache 1154, and shared memory 1153. For example, the execution resources 1156A-1156D can share an instruction cache 1154 and shared memory 1153, as well as multiple instances of a texture and/or data cache memory 1158A-1158B. The various components can communicate via an interconnect fabric 1152 similar to the interconnect fabric 1127 of FIG. 11A.

Persons skilled in the art will understand that the architecture described in FIGS. 1, 10A-10D, and 11A-11B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 1002 of FIG. 10A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (e.g., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 11C illustrates a graphics processing unit (GPU) 1180 which includes dedicated sets of graphics processing resources arranged into multi-core groups 1165A-1165N. While the details of only a single multi-core group 1165A are provided, it will be appreciated that the other multi-core groups 1165B-1165N may be equipped with the same or similar sets of graphics processing resources. Details described with respect to the multi-core groups 1165A-1165N may also apply to any graphics multiprocessor 1034, 1125, 1150 described herein.

As illustrated, a multi-core group 1165A may include a set of graphics cores 1170, a set of tensor cores 1171, and a set of ray tracing cores 1172. A scheduler/dispatcher 1168 schedules and dispatches the graphics threads for execution on the various cores 1170, 1171, 1172. A set of register files 1169 store operand values used by the cores 1170, 1171, 1172 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 1173 store graphics data such as texture data, vertex data, pixel data, ray data, bounding volume data, etc., locally within each multi-core group 1165A. One or more texture units 1174 can also be used to perform texturing operations, such as texture mapping and sampling. A Level 2 (L2) cache 1175 shared by all or a subset of the multi-core groups 1165A-1165N stores graphics data and/or instructions for multiple concurrent graphics threads. As illustrated, the L2 cache 1175 may be shared across a plurality of multi-core groups 1165A-1165N. One or more memory controllers 1167 couple the GPU 1180 to a memory 1166 which may be a system memory (e.g., DRAM) and/or a dedicated graphics memory (e.g., GDDR6 memory).

Input/output (I/O) circuitry 1163 couples the GPU 1180 to one or more I/O devices 1162 such as digital signal processors (DSPs), network controllers, or user input devices. An on-chip interconnect may be used to couple the I/O devices 1162 to the GPU 1180 and memory 1166. One or more I/O memory management units (IOMMUs) 1164 of the I/O circuitry 1163 couple the I/O devices 1162 directly to the system memory 1166. Optionally, the IOMMU 1164 manages multiple sets of page tables to map virtual addresses to physical addresses in system memory 1166. The I/O devices 1162, CPU(s) 1161, and GPU(s) 1180 may then share the same virtual address space.

In one implementation of the IOMMU 1164, the IOMMU 1164 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 1166). The base addresses of each of the first and second sets of page tables may be stored in control registers and swapped out on a context switch (e.g., so that the new context is provided with access to the relevant set of page tables). While not illustrated in FIG. 11C, each of the cores 1170, 1171, 1172 and/or multi-core groups 1165A-1165N may include translation lookaside buffers (TLBs) to cache guest virtual to guest physical translations, guest physical to host physical translations, and guest virtual to host physical translations.

The CPU(s) 1161, GPUs 1180, and I/O devices 1162 may be integrated on a single semiconductor chip and/or chip package. The illustrated memory 1166 may be integrated on the same chip or may be coupled to the memory controllers 1167 via an off-chip interface. In one implementation, the memory 1166 comprises GDDR6 memory which shares the same virtual address space as other physical system-level memories, although the underlying principles described herein are not limited to this specific implementation.

The tensor cores 1171 may include a plurality of execution units specifically designed to perform matrix operations, which are the fundamental compute operations used to perform deep learning operations. For example, simultaneous matrix multiplication operations may be used for neural network training and inferencing. The tensor cores 1171 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 1171. The training of neural networks, in particular, requires a significant number of matrix dot product operations. In order to process an inner-product formulation of an N×N×N matrix multiply, the tensor cores 1171 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1171 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat 16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 1171 support a sparse mode of operation for matrices in which the vast majority of values are zero. The tensor cores 1171 include support for sparse input matrices that are encoded in a sparse matrix representation (e.g., coordinate list encoding (COO), compressed sparse row (CSR), compress sparse column (CSC), etc.). The tensor cores 1171 also include support for compressed sparse matrix representations in the event that the sparse matrix representation may be further compressed. Compressed, encoded, and/or compressed and encoded matrix data, along with associated compression and/or encoding metadata, can be read by the tensor cores 1171 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 1171, output matrix C may be output in a compressed format, a sparse encoding, or a compressed sparse encoding.

The ray tracing cores 1172 may accelerate ray tracing operations for both real-time ray tracing and non-real-time ray tracing implementations. In particular, the ray tracing cores 1172 may include ray traversal/intersection circuitry for performing ray traversal using bounding volume hierarchies (BVHs) and identifying intersections between rays and primitives enclosed within the BVH volumes. The ray tracing cores 1172 may also include circuitry for performing depth testing and culling (e.g., using a Z buffer or similar arrangement). In one implementation, the ray tracing cores 1172 perform traversal and intersection operations in concert with the image denoising techniques described herein, at least a portion of which may be executed on the tensor cores 1171. For example, the tensor cores 1171 may implement a deep learning neural network to perform denoising of frames generated by the ray tracing cores 1172. However, the CPU(s) 1161, graphics cores 1170, and/or ray tracing cores 1172 may also implement all or a portion of the denoising and/or deep learning algorithms.

In addition, as described above, a distributed approach to denoising may be employed in which the GPU 1180 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 1172 may process all BVH traversal and/or ray-primitive intersections, saving the graphics cores 1170 from being overloaded with thousands of instructions per ray. For example, each ray tracing core 1172 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 1165A can simply launch a ray probe, and the ray tracing cores 1172 independently perform ray traversal and intersection and return hit data (e.g., a hit, no hit, multiple hits, etc.) to the thread context. The other cores 1170, 1171 are freed to perform other graphics or compute work while the ray tracing cores 1172 perform the traversal and intersection operations.

Optionally, each ray tracing core 1172 may include a traversal unit to perform BVH testing operations and/or an intersection unit which performs ray-primitive intersection tests. The intersection unit generates a “hit,” “no hit,” or “multiple hit” response, which it provides to the appropriate thread. During the traversal and intersection operations, the execution resources of the other cores (e.g., graphics cores 1170 and tensor cores 1171) are freed to perform other forms of graphics work.

In some examples described below, a hybrid rasterization/ray tracing approach is used in which work is distributed between the graphics cores 1170 and ray tracing cores 1172.

The ray tracing cores 1172 (and/or other cores 1170, 1171) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1172, graphics cores 1170 and tensor cores 1171 is Vulkan API (e.g., Vulkan version 1.1.85 and later). Note, however, that the underlying principles described herein are not limited to any particular ray tracing ISA.

In general, the various cores 1172, 1171, 1170 may support a ray tracing instruction set that includes instructions/functions for one or more of ray generation, closest hit, any hit, ray-primitive intersection, per-primitive and hierarchical bounding box construction, miss, visit, and exceptions. More specifically, some examples include ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction-This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 1172 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1172 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1172 can also be used to perform computations that are not directly analogous to ray tracing. For example, mesh projection, mesh refinement, and volume sampling computations can be accelerated using the ray tracing cores 1172. Generic coordinate space calculations, such as nearest neighbor calculations can also be performed. For example, the set of points near a given point can be discovered by defining a bounding box in the coordinate space around the point. BVH and ray probe logic within the ray tracing cores 1172 can then be used to determine the set of point intersections within the bounding box. The intersections constitute the origin point and the nearest neighbors to that origin point. Computations that are performed using the ray tracing cores 1172 can be performed in parallel with computations performed on the graphics cores 1172 and tensor cores 1171. A shader compiler can be configured to compile a compute shader or other general-purpose graphics processing program into low level primitives that can be parallelized across the graphics cores 1170, tensor cores 1171, and ray tracing cores 1172.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

### Example Core Architectures-In-order and Out-of-Order Core Block Diagram

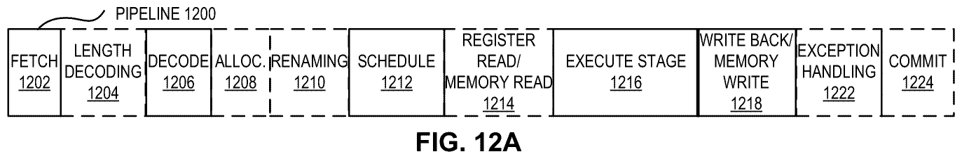

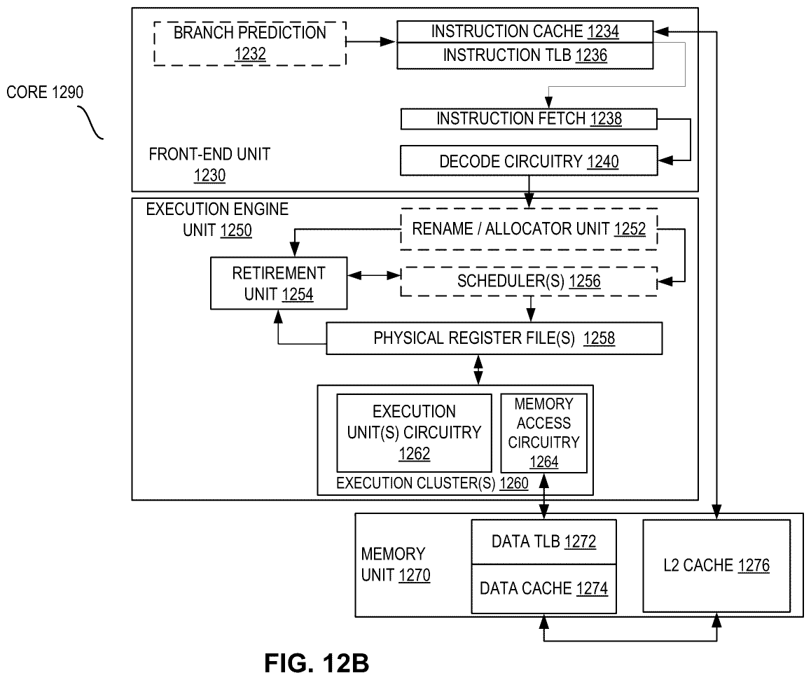

FIG. 12A is a block diagram illustrating both an example in-order pipeline and an example register renaming, out-of-order issue/execution pipeline according to examples. FIG. 12B is a block diagram illustrating both an example in-order architecture core and an example register renaming, out-of-order issue/execution architecture core to be included in a processor according to examples. The solid lined boxes in FIGS. 12A-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 12A, a processor pipeline 1200 includes a fetch stage 1202, an optional length decoding stage 1204, a decode stage 1206, an optional allocation (Alloc) stage 1208, an optional renaming stage 1210, a schedule (also known as a dispatch or issue) stage 1212, an optional register read/memory read stage 1214, an execute stage 1216, a write back/memory write stage 1218, an optional exception handling stage 1222, and an optional commit stage 1224. One or more operations can be performed in each of these processor pipeline stages. For example, during the fetch stage 1202, one or more instructions are fetched from instruction memory, and during the decode stage 1206, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1206 and the register read/memory read stage 1214 may be combined into one pipeline stage. In some examples, during the execute stage 1216, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 12B may implement the pipeline 1200 as follows: 1) the instruction fetch circuitry 1238 performs the fetch and length decoding stages 1202 and 1204; 2) the decode circuitry 1240 performs the decode stage 1206; 3) the rename/allocator unit circuitry 1252 performs the allocation stage 1208 and renaming stage 1210; 4) the scheduler(s) circuitry 1256 performs the schedule stage 1212; 5) the physical register file(s) circuitry 1258 and the memory unit circuitry 1270 perform the register read/memory read stage 1214; the execution cluster(s) 1260 perform the execute stage 1216; 6) the memory unit circuitry 1270 and the physical register file(s) circuitry 1258 perform the write back/memory write stage 1218; 7) various circuitry may be involved in the exception handling stage 1222; and 8) the retirement unit circuitry 1254 and the physical register file(s) circuitry 1258 perform the commit stage 1224.

FIG. 12B shows a processor core 1290 including front-end unit circuitry 1230 coupled to execution engine unit circuitry 1250, and both are coupled to memory unit circuitry 1270. The core 1290 may be a reduced instruction set architecture computing (RISC) core, a complex instruction set architecture computing (CISC) core, a very long instruction word (VLIW) core, or a hybrid or alternative core type. As yet another option, the core 1290 may be a special-purpose core, such as, for example, a network or communication core, compression engine, coprocessor core, general purpose computing graphics processing unit (GPGPU) core, graphics core, or the like.

The front-end unit circuitry 1230 may include branch prediction circuitry 1232 coupled to instruction cache circuitry 1234, which is coupled to an instruction translation lookaside buffer (TLB) 1236, which is coupled to instruction fetch circuitry 1238, which is coupled to decode circuitry 1240. In some examples, the instruction cache circuitry 1234 is included in the memory unit circuitry 1270 rather than the front-end circuitry 1230. The decode circuitry 1240 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1240 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1240 may be implemented using various different mechanisms. Examples of suitable mechanisms include, but are not limited to, look-up tables, hardware implementations, programmable logic arrays (PLAs), microcode read only memories (ROMs), etc. In some examples, the core 1290 includes a microcode ROM (not shown) or other medium that stores microcode for certain macroinstructions (e.g., in decode circuitry 1240 or otherwise within the front-end circuitry 1230). In some examples, the decode circuitry 1240 includes a micro-operation (micro-op) or operation cache (not shown) to hold/cache decoded operations, micro-tags, or micro-operations generated during the decode or other stages of the processor pipeline 1200. The decode circuitry 1240 may be coupled to rename/allocator unit circuitry 1252 in the execution engine circuitry 1250.

The execution engine circuitry 1250 includes the rename/allocator unit circuitry 1252 coupled to retirement unit circuitry 1254 and a set of one or more scheduler(s) circuitry 1256. The scheduler(s) circuitry 1256 represents any number of different schedulers, including reservations stations, central instruction window, etc. In some examples, the scheduler(s) circuitry 1256 can include arithmetic logic unit (ALU) scheduler/scheduling circuitry, ALU queues, address generation unit (AGU) scheduler/scheduling circuitry, AGU queues, etc. The scheduler(s) circuitry 1256 is coupled to the physical register file(s) circuitry 1258. Each of the physical register file(s) circuitry 1258 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1258 includes vector registers unit circuitry, writemask registers unit circuitry, and scalar register unit circuitry. These register units may provide architectural vector registers, vector mask registers, general-purpose registers, etc. The physical register file(s) circuitry 1258 is coupled to the retirement unit circuitry 1254 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1254 and the physical register file(s) circuitry 1258 are coupled to the execution cluster(s) 1260. The execution cluster(s) 1260 includes a set of one or more execution unit(s) circuitry 1262 and a set of one or more memory access circuitry 1264. The execution unit(s) circuitry 1262 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1256, physical register file(s) circuitry 1258, and execution cluster(s) 1260 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster-and in the case of a separate memory access pipeline, certain examples are implemented in which only the execution cluster of this pipeline has the memory access unit(s) circuitry 1264). It should also be understood that where separate pipelines are used, one or more of these pipelines may be out-of-order issue/execution and the rest in-order.

In some examples, the execution engine unit circuitry 1250 may perform load store unit (LSU) address/data pipelining to an Advanced Microcontroller Bus (AMB) interface (not shown), and address phase and writeback, data phase load, store, and branches.

The set of memory access circuitry 1264 is coupled to the memory unit circuitry 1270, which includes data TLB circuitry 1272 coupled to data cache circuitry 1274 coupled to level 2 (L2) cache circuitry 1276. In some examples, the memory access circuitry 1264 may include load unit circuitry, store address unit circuitry, and store data unit circuitry, each of which is coupled to the data TLB circuitry 1272 in the memory unit circuitry 1270. The instruction cache circuitry 1234 is further coupled to the level 2 (L2) cache circuitry 1276 in the memory unit circuitry 1270. In some examples, the instruction cache 1234 and the data cache 1274 are combined into a single instruction and data cache (not shown) in L2 cache circuitry 1276, level 3 (L3) cache circuitry (not shown), and/or main memory. The L2 cache circuitry 1276 is coupled to one or more other levels of cache and eventually to a main memory.

The core 1290 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In some examples, the core 1290 includes logic to support a packed data instruction set architecture extension (e.g., AVX1, AVX2), thereby allowing the operations used by many multimedia applications to be performed using packed data.

### Example Execution Unit(s) Circuitry

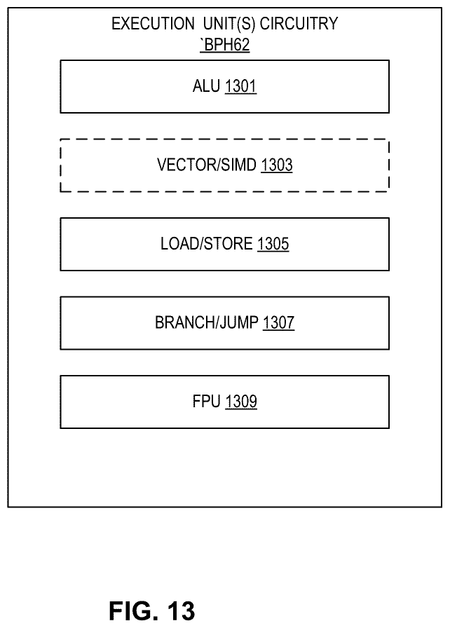

FIG. 13 illustrates examples of execution unit(s) circuitry, such as execution unit(s) circuitry 1262 of FIG. 12B. As illustrated, execution unit(s) circuity 1262 may include one or more ALU circuits 1301, optional vector/single instruction multiple data (SIMD) circuits 1303, load/store circuits 1305, branch/jump circuits 1307, and/or Floating-point unit (FPU) circuits 1309. ALU circuits 1301 perform integer arithmetic and/or Boolean operations. Vector/SIMD circuits 1303 perform vector/SIMD operations on packed data (such as SIMD/vector registers). Load/store circuits 1305 execute load and store instructions to load data from memory into registers or store from registers to memory. Load/store circuits 1305 may also generate addresses. Branch/jump circuits 1307 cause a branch or jump to a memory address depending on the instruction. FPU circuits 1309 perform floating-point arithmetic. The width of the execution unit(s) circuitry 1262 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

FIG. 14 is a block diagram of a register architecture 1400 according to some examples. As illustrated, the register architecture 1400 includes vector/SIMD registers 1410 that vary from 128-bit to 1,024 bits width, and some vector registers can even have 1024 bytes (and they may be referred to as tile registers). In some examples, the vector/SIMD registers 1410 are physically 512-bits and, depending upon the mapping, only some of the lower bits are used. For example, in some examples, the vector/SIMD registers 1410 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1400 includes writemask/predicate registers 1415. For example, in some examples, there are 8 writemask/predicate registers (sometimes called k0 through k7) that are each 16-bit, 32-bit, 64-bit, or 128-bit in size. Writemask/predicate registers 1415 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1415 corresponds to a data element position of the destination. In other examples, the writemask/predicate registers 1415 are scalable and consists of a set number of enable bits for a given vector element (e.g., 8 enable bits per 64-bit vector element).

The register architecture 1400 includes a plurality of general-purpose registers 1425. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1400 includes scalar floating-point (FP) register file 1445 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1440 (e.g., EFLAGS, RFLAGS, etc.) store status and control information for arithmetic, compare, and system operations. For example, the one or more flag registers 1440 may store condition code information such as carry, parity, auxiliary carry, zero, sign, and overflow. In some examples, the one or more flag registers 1440 are called program status and control registers.

Segment registers 1420 contain segment points for use in accessing memory. In some examples, these registers are referenced by the names CS, DS, SS, ES, FS, and GS.

Model specific registers or machine specific registers (MSRs) 1435 control and report on processor performance. Most MSRs 1435 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1460 consist of control, status, and error reporting MSRs that are used to detect and report on hardware errors. Control register(s) 1455 (e.g., CR0-CR4) determine the operating mode of a processor (e.g., processor 870, 880, 838, 815, and/or 700) and the characteristics of a currently executing task. In some examples, MSRs 1435 are a subset of control registers 1455.

One or more instruction pointer register(s) 1430 store an instruction pointer value. Debug registers 1450 control and allow for the monitoring of a processor or core's debugging operations.

Memory (mem) management registers 1465 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1400 may, for example, be used in register file/memory, or physical register file(s) circuitry 1258.

### Graphics Execution Units

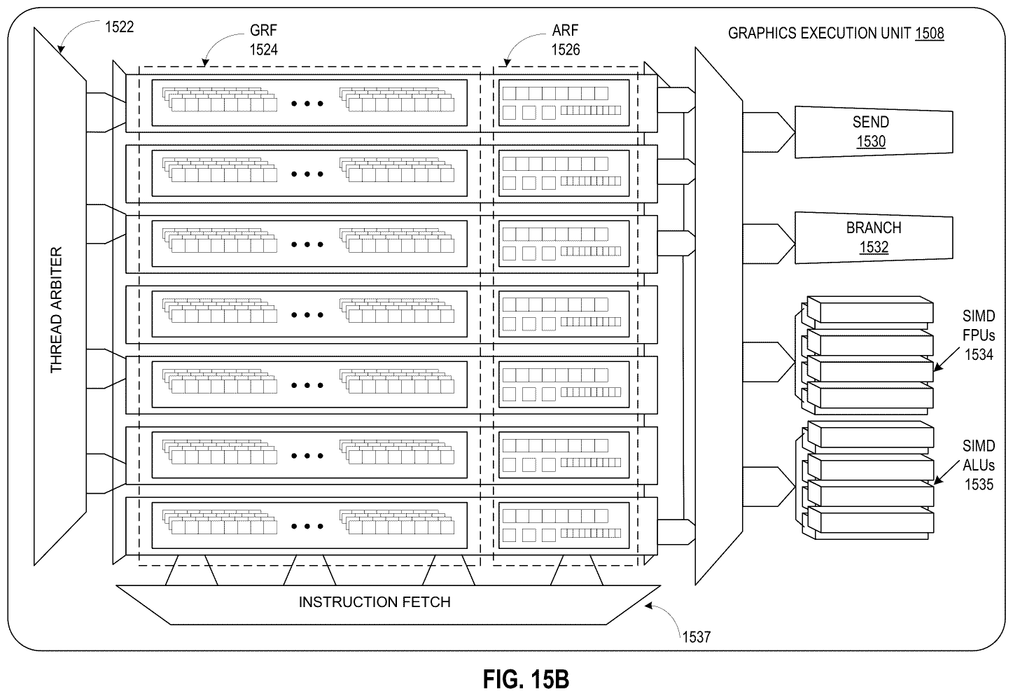

FIGS. 15A-15B illustrate thread execution logic 1500 including an array of processing elements employed in a graphics processor core according to examples described herein. Elements of FIGS. 15A-15B having the same reference numbers (or names) as the elements of any other figure herein can operate or function in any manner similar to that described elsewhere herein, but are not limited to such. FIG. 15A is representative of an execution unit within a general-purpose graphics processor, while FIG. 15B is representative of an execution unit that may be used within a compute accelerator.

As illustrated in FIG. 15A, in some examples thread execution logic 1500 includes a shader processor 1502, a thread dispatcher 1504, instruction cache 1506, a scalable execution unit array including a plurality of execution units 1508A-1508N, a sampler 1510, shared local memory 1511, a data cache 1512, and a data port 1514. In some examples the scalable execution unit array can dynamically scale by enabling or disabling one or more execution units (e.g., any of execution units 1508A, 1508B, 1508C, 1508D, through 1508N-1 and 1508N) based on the computational requirements of a workload. In some examples the included components are interconnected via an interconnect fabric that links to each of the components. In some examples, thread execution logic 1500 includes one or more connections to memory, such as system memory or cache memory, through one or more of instruction cache 1506, data port 1514, sampler 1510, and execution units 1508A-1508N. In some examples, each execution unit (e.g. 1508A) is a stand-alone programmable general-purpose computational unit that is capable of executing multiple simultaneous hardware threads while processing multiple data elements in parallel for each thread. In various examples, the array of execution units 1508A-1508N is scalable to include any number individual execution units.

In some examples, the execution units 1508A-1508N are primarily used to execute shader programs. A shader processor 1502 can process the various shader programs and dispatch execution threads associated with the shader programs via a thread dispatcher 1504. In some examples the thread dispatcher includes logic to arbitrate thread initiation requests from the graphics and media pipelines and instantiate the requested threads on one or more execution unit in the execution units 1508A-1508N. For example, a geometry pipeline can dispatch vertex, tessellation, or geometry shaders to the thread execution logic for processing. In some examples, thread dispatcher 1504 can also process runtime thread spawning requests from the executing shader programs.

In some examples, the execution units 1508A-1508N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 1508A-1508N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 1508A-1508N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 1508A-1508N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 1508A-1508N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused execution unit 1509A-1509N having thread control logic (1507A-1507N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 1509A-1509N includes at least two execution units. For example, fused execution unit 1509A includes a first EU 1508A, second EU 1508B, and thread control logic 1507A that is common to the first EU 1508A and the second EU 1508B. The thread control logic 1507A controls threads executed on the fused graphics execution unit 1509A, allowing each EU within the fused execution units 1509A-1509N to execute using a common instruction pointer register.

One or more internal instruction caches (e.g., 1506) are included in the thread execution logic 1500 to cache thread instructions for the execution units. In some examples, one or more data caches (e.g., 1512) are included to cache thread data during thread execution. Threads executing on the execution logic 1500 can also store explicitly managed data in the shared local memory 1511. In some examples, a sampler 1510 is included to provide texture sampling for 3D operations and media sampling for media operations. In some examples, sampler 1510 includes specialized texture or media sampling functionality to process texture or media data during the sampling process before providing the sampled data to an execution unit.

During execution, the graphics and media pipelines send thread initiation requests to thread execution logic 1500 via thread spawning and dispatch logic. Once a group of geometric objects has been processed and rasterized into pixel data, pixel processor logic (e.g., pixel shader logic, fragment shader logic, etc.) within the shader processor 1502 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 1502 then executes an application programming interface (API)-supplied pixel or fragment shader program. To execute the shader program, the shader processor 1502 dispatches threads to an execution unit (e.g., 1508A) via thread dispatcher 1504. In some examples, shader processor 1502 uses texture sampling logic in the sampler 1510 to access texture data in texture maps stored in memory. Arithmetic operations on the texture data and the input geometry data compute pixel color data for each geometric fragment, or discards one or more pixels from further processing.

In some examples, the data port 1514 provides a memory access mechanism for the thread execution logic 1500 to output processed data to memory for further processing on a graphics processor output pipeline. In some examples, the data port 1514 includes or couples to one or more cache memories (e.g., data cache 1512) to cache data for memory access via the data port.

In some examples, the execution logic 1500 can also include a ray tracer 1505 that can provide ray tracing acceleration functionality. The ray tracer 1505 can support a ray tracing instruction set that includes instructions/functions for ray generation.

FIG. 15B illustrates exemplary internal details of an execution unit 1508, according to examples. A graphics execution unit 1508 can include an instruction fetch unit 1537, a general register file array (GRF) 1524, an architectural register file array (ARF) 1526, a thread arbiter 1522, a send unit 1530, a branch unit 1532, a set of SIMD floating point units (FPUs) 1534, and in some examples a set of dedicated integer SIMD ALUs 1535. The GRF 1524 and ARF 1526 includes the set of general register files and architecture register files associated with each simultaneous hardware thread that may be active in the graphics execution unit 1508. In some examples, per thread architectural state is maintained in the ARF 1526, while data used during thread execution is stored in the GRF 1524. The execution state of each thread, including the instruction pointers for each thread, can be held in thread-specific registers in the ARF 1526.

In some examples the graphics execution unit 1508 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 1508 is not limited to the number of hardware threads, and multiple logical threads can be assigned to each hardware thread.

In some examples, the graphics execution unit 1508 can co-issue multiple instructions, which may each be different instructions. The thread arbiter 1522 of the graphics execution unit thread 1508 can dispatch the instructions to one of the send unit 1530, branch unit 1532, or SIMD FPU(s) 1534 for execution. Each execution thread can access 128 general-purpose registers within the GRF 1524, where each register can store 32 bytes, accessible as a SIMD 8-element vector of 32-bit data elements. In some examples, each execution unit thread has access to 4 Kbytes within the GRF 1524, although examples are not so limited, and greater or fewer register resources may be provided in other examples. In some examples the graphics execution unit 1508 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 1524 can store a total of 28 Kbytes. Where 16 threads may access 4 Kbytes, the GRF 1524 can store a total of 64 Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 1530. In some examples, branch instructions are dispatched to a dedicated branch unit 1532 to facilitate SIMD divergence and eventual convergence.

In some examples the graphics execution unit 1508 includes one or more SIMD floating point units (FPU(s)) 1534 to perform floating-point operations. In some examples, the FPU(s) 1534 also support integer computation. In some examples the FPU(s) 1534 can SIMD execute up to M number of 32-bit floating-point (or integer) operations, or SIMD execute up to 2M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 1535 are also present, and may be specifically optimized to perform operations associated with machine learning computations.

In some examples, arrays of multiple instances of the graphics execution unit 1508 can be instantiated in a graphics sub-core grouping (e.g., a sub-slice). For scalability, product architects can choose the exact number of execution units per sub-core grouping. In some examples the execution unit 1508 can execute instructions across a plurality of execution channels. In a further example, each thread executed on the graphics execution unit 1508 is executed on a different channel.

FIG. 16 illustrates an additional execution unit 1600, according to an example. In some examples, the execution unit 1600 includes a thread control unit 1601, a thread state unit 1602, an instruction fetch/prefetch unit 1603, and an instruction decode unit 1604. The execution unit 1600 additionally includes a register file 1606 that stores registers that can be assigned to hardware threads within the execution unit. The execution unit 1600 additionally includes a send unit 1607 and a branch unit 1608. In some examples, the send unit 1607 and branch unit 1608 can operate similarly as the send unit 1530 and a branch unit 1532 of the graphics execution unit 1508 of FIG. 15B.

The execution unit 1600 also includes a compute unit 1610 that includes multiple different types of functional units. In some examples the compute unit 1610 includes an ALU unit 1611 that includes an array of arithmetic logic units. The ALU unit 1611 can be configured to perform 64-bit, 32-bit, and 16-bit integer and floating point operations. Integer and floating point operations may be performed simultaneously. The compute unit 1610 can also include a systolic array 1612, and a math unit 1613. The systolic array 1612 includes a W wide and D deep network of data processing units that can be used to perform vector or other data-parallel operations in a systolic manner. In some examples the systolic array 1612 can be configured to perform matrix operations, such as matrix dot product operations. In some examples the systolic array 1612 support 16-bit floating point operations, as well as 8-bit and 4-bit integer operations. In some examples the systolic array 1612 can be configured to accelerate machine learning operations. In such examples, the systolic array 1612 can be configured with support for the bfloat 16-bit floating point format. In some examples, a math unit 1613 can be included to perform a specific subset of mathematical operations in an efficient and lower-power manner than then ALU unit 1611. The math unit 1613 can include a variant of math logic that may be found in shared function logic of a graphics processing engine provided by other examples. In some examples the math unit 1613 can be configured to perform 32-bit and 64-bit floating point operations.

The thread control unit 1601 includes logic to control the execution of threads within the execution unit. The thread control unit 1601 can include thread arbitration logic to start, stop, and preempt execution of threads within the execution unit 1600. The thread state unit 1602 can be used to store thread state for threads assigned to execute on the execution unit 1600. Storing the thread state within the execution unit 1600 enables the rapid pre-emption of threads when those threads become blocked or idle. The instruction fetch/prefetch unit 1603 can fetch instructions from an instruction cache of higher level execution logic (e.g., instruction cache 1506 as in FIG. 15A). The instruction fetch/prefetch unit 1603 can also issue prefetch requests for instructions to be loaded into the instruction cache based on an analysis of currently executing threads. The instruction decode unit 1604 can be used to decode instructions to be executed by the compute units. In some examples, the instruction decode unit 1604 can be used as a secondary decoder to decode complex instructions into constituent micro-operations.

The execution unit 1600 additionally includes a register file 1606 that can be used by hardware threads executing on the execution unit 1600. Registers in the register file 1606 can be divided across the logic used to execute multiple simultaneous threads within the compute unit 1610 of the execution unit 1600. The number of logical threads that may be executed by the graphics execution unit 1600 is not limited to the number of hardware threads, and multiple logical threads can be assigned to each hardware thread. The size of the register file 1606 can vary across examples based on the number of supported hardware threads. In some examples, register renaming may be used to dynamically allocate registers to hardware threads.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

### Further Examples

Example 1 provides an exemplary method comprising: dedicating a first subset of a plurality of vector registers to a first thread of a plurality of threads for thread execution; and responsive to a context switch from the first thread to a second thread, bypassing saving a state of the first subset of the plurality of vector registers; and saving a state of a second subset of the plurality of vector registers, wherein the second subset of the plurality of vector registers is not dedicated to the first thread, and wherein the first and second subsets are mutually exclusive.

Example 2 includes the substance of Example 1, further comprising: responsive to a subsequent context switch from the second thread to the first thread, bypassing restoring the state of the first subset of the plurality of vector registers and restoring the state of the second subset.

Example 3 includes the substance of Examples 1 to 2, wherein saving the state of the second subset of the plurality of vector registers is performed based on a detection of an access to the second subset of the plurality of vector registers by the second thread, wherein access to the second subset is then granted to the second thread.

Example 4 includes the substance of Examples 1 to 3, wherein the detection of the access to the second subset is based on an operating system call.

Example 5 includes the substance of Examples 1 to 4, wherein access to the second subset is saved in a record, and wherein which vector register is to be included in the second subset in a subsequent context switch may be identified based on the record.

Example 6 includes the substance of Examples 1 to 5, wherein saving the state of the second subset comprises saving information in a first memory location, the information obtained through executing a first command to associate a second memory location with the second subset, wherein the second subset is to write the state of the second subset to the second memory location.

Example 7 includes the substance of Examples 1 to 6, wherein the first memory location stores the state of the first thread.

Example 8 includes the substance of Examples 1 to 7, wherein upon a subsequent context switch to restore the first thread, the state of the second subset is restored through executing a second command to restore the state of the second subset from the second memory location, and wherein the second command uses the information saved in the first memory location that stores the state of the first thread.

Example 9 includes the substance of Examples 1 to 8, wherein during the execution of the second thread, the state of the first subset is maintained.

Example 10 includes the substance of Examples 1 to 9, wherein a central processing unit (CPU), a graphics processing unit (GPU), a neural processing unit, a tensor processing unit, a matrix math unit comprises the processor core.

Example 11 provides an exemplary method comprising: executing a first thread on a processor, wherein the first thread is associated with a first type of workload; saving a state of the first thread upon a thread swap event, wherein the state of the first thread includes state of at least one of registers, caches, and execution circuits to perform specific tasks; executing a second thread on the processor, wherein the second thread is associated with a second type of workload; bypassing saving of at least part of the state of the second thread upon a subsequent thread swap event; and selectively managing the state of the first and second threads based on an association of the threads with respective types of workloads, wherein the state of the first thread is preserved for continuity of execution of the first type of workload and the at least part of the state of the second thread is not restored.

Example 12 includes the substance of Example 11, wherein the processor comprises logic configured to determine whether a thread is associated with the second type of workload and to control the saving and bypassing of a state of the thread accordingly.

Example 13 includes the substance of Examples 11 to 12, wherein bypassing the saving of at least part of the state of the second thread includes maintaining a state of registers specific to the second thread during execution.

Example 14 includes the substance of Examples 11 to 13, further comprising restoring the state of the first thread upon resumption of the first thread after the subsequent thread swap event, while maintaining uninterrupted execution of the second thread without restoring its state.

Example 15 includes the substance of Examples 11 to 14, wherein the second type of workload includes tasks selected from a group consisting of machine learning algorithms, neural network processing, and data analytics.

Example 16 provides a processor, comprising: logic to coordinate execution of threads and a plurality of vector registers to be assigned to the threads for thread execution, the thread execution comprising: dedicating a first subset of a plurality of vector registers to a first thread of the plurality of threads for thread execution; and responsive to a context switch from the first thread to a second thread, bypassing saving a state of the first subset of the plurality of vector registers; and saving a state of a second subset of the plurality of vector registers, wherein the second subset of the plurality of vector registers is not dedicated to the first thread, and wherein the first and second subsets are mutually exclusive.

Example 17 includes the substance of Example 16, wherein saving the state of a second subset of the plurality of vector registers is performed based on a detection of an access to the second subset of the plurality of vector registers by the second thread, wherein access to the second subset is then granted to the second thread.

Example 18 includes the substance of Examples 16 to 17, wherein saving the state of the second subset comprises saving information in a first memory location, the information obtained through executing a first command to associate a second memory location with the second subset, wherein the second subset is to write the state of the second subset to the second memory location.

Example 19 includes the substance of Examples 16 to 18, wherein the first memory location stores the state of the first thread.

Example 20 includes the substance of Examples 16 to 19, wherein upon a subsequent context switch to restore the first thread, the state of the second subset is restored through executing a second command to restore the state of the second subset from the second memory location, and wherein the second command uses the information saved in the first memory location that stores the state of the first thread.

### Additional Explanation

As described herein, instructions may refer to specific configurations of hardware such as application specific integrated circuits (ASICs) configured to perform certain operations or having a predetermined functionality or software instructions stored in memory embodied in a non-transitory computer-readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical, or other form of propagated signals-such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more buses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the disclosure may be implemented using different combinations of software, firmware, and/or hardware. Throughout this detailed description, for the purposes of explanation, numerous specific details were set forth in order to provide a thorough understanding of the present disclosure. It will be apparent, however, to one skilled in the art that the disclosure may be practiced without some of these specific details. In certain instances, well-known structures and functions were not described in elaborate detail in order to avoid obscuring the subject matter of the present disclosure. Accordingly, the scope and spirit of the disclosure should be judged in terms of the claims which follow.

What is claimed is:

1. A method to execute a plurality of threads on a processor core within a set of processor cores of a processor, comprising:
dedicating a first subset of a plurality of vector registers to a first thread of the plurality of threads for thread execution; and
responsive to a context switch from the first thread to a second thread,
bypassing saving a state of the first subset of the plurality of vector registers; and
saving a state of a second subset of the plurality of vector registers, wherein the second subset of the plurality of vector registers is not dedicated to the first thread, and wherein the first and second subsets are mutually exclusive.

2. The method of claim 1, further comprising:
responsive to a subsequent context switch from the second thread to the first thread, bypassing restoring the state of the first subset of the plurality of vector registers and restoring the state of the second subset.

3. The method of claim 1, wherein saving the state of the second subset of the plurality of vector registers is performed based on a detection of an access to the second subset of the plurality of vector registers by the second thread, wherein access to the second subset is then granted to the second thread.

4. The method of claim 3, wherein the detection of the access to the second subset is based on an operating system call.

5. The method of claim 1, wherein access to the second subset is saved in a record, and wherein which vector register is to be included in the second subset in a subsequent context switch may be identified based on the record.

6. The method of claim 1, wherein saving the state of the second subset comprises saving information in a first memory location, the information obtained through executing a first command to associate a second memory location with the second subset, wherein the second subset is to write the state of the second subset to the second memory location.

7. The method of claim 6, wherein the first memory location stores the state of the first thread.

8. The method of claim 7, wherein upon a subsequent context switch to restore the first thread, the state of the second subset is restored through executing a second command to restore the state of the second subset from the second memory location, and wherein the second command uses the information saved in the first memory location that stores the state of the first thread.

9. The method of claim 1, wherein during the execution of the second thread, the state of the first subset is maintained.

10. The method of claim 1, wherein a central processing unit (CPU), a graphics processing unit (GPU), a neural processing unit, a tensor processing unit, a matrix math unit comprises the processor core.

11. A method comprising:
executing a first thread on a processor, wherein the first thread is associated with a first type of workload;
saving a state of the first thread upon a thread swap event, wherein the state of the first thread includes state of at least one of registers, caches, and execution circuits to perform specific tasks;
executing a second thread on the processor, wherein the second thread is associated with a second type of workload;
bypassing saving of at least part of the state of the second thread upon a subsequent thread swap event; and
selectively managing the state of the first and second threads based on an association of the threads with respective types of workloads, wherein the state of the first thread is preserved for continuity of execution of the first type of workload and the at least part of the state of the second thread is not restored.

12. The method of claim 11, wherein the processor comprises logic configured to determine whether a thread is associated with the second type of workload and to control the saving and bypassing of a state of the thread accordingly.

13. The method of claim 11, wherein bypassing the saving of at least part of the state of the second thread includes maintaining a state of registers specific to the second thread during execution.

14. The method of claim 11, further comprising restoring the state of the first thread upon resumption of the first thread after the subsequent thread swap event, while maintaining uninterrupted execution of the second thread without restoring the state of the second thread.

15. The method of claim 11, wherein the second type of workload includes tasks selected from a group consisting of machine learning algorithms, neural network processing, and data analytics.

16. A processor comprising:
logic to coordinate execution of threads; and
a plurality of vector registers to be assigned to the threads for thread execution, the thread execution comprising:
dedicating a first subset of a plurality of vector registers to a first thread of the plurality of threads for thread execution; and
responsive to a context switch from the first thread to a second thread,
bypassing saving a state of the first subset of the plurality of vector registers; and
saving a state of a second subset of the plurality of vector registers, wherein the second subset of the plurality of vector registers is not dedicated to the first thread, and wherein the first and second subsets are mutually exclusive.

17. The processor of claim 16, wherein saving the state of the second subset of the plurality of vector registers is performed based on a detection of an access to the second subset of the plurality of vector registers by the second thread, wherein access to the second subset is then granted to the second thread.

18. The processor of claim 16, wherein saving the state of the second subset comprises saving information in a first memory location, the information obtained through executing a first command to associate a second memory location with the second subset, wherein the second subset is to write the state of the second subset to the second memory location.

19. The processor of claim 18, wherein the first memory location stores the state of the first thread.

20. The processor of claim 19, wherein upon a subsequent context switch to restore the first thread, the state of the second subset is restored through executing a second command to restore the state of the second subset from the second memory location, and wherein the second command uses the information saved in the first memory location that stores the state of the first thread.
